(19) United States
(12) Patent Application Publication
(10) Pub. No.: US 2014/0295030 A1
(43) Pub. Date: Oct. 2, 2014

(54) YOGURT SMOOTHIE KIT AND METHODS FOR MAKING THE SAME

(71) Applicants: Raymond Warren Downes, Westlake Village, CA (US); Jonathan Rodacy, Westlake Village, CA (US); Andres Del Rosal, Wayzata, MN (US); Vincent M. Cavallini, Wayzata, MN (US)

(72) Inventors: Raymond Warren Downes, Westlake Village, CA (US); Jonathan Rodacy, Westlake Village, CA (US); Andres Del Rosal, Wayzata, MN (US); Vincent M. Cavallini, Wayzata, MN (US)

(73) Assignees: Cargill, Incorporated, Wayzata, MN (US); Dole Packaged Foods, LLC, Westlake Village, CA (US)

(21) Appl. No.: 14/232,223

(22) PCT Filed: Jul. 12, 2012
(86) PCT No.: PCT/US12/46531

§ 371 Date: Jun. 10, 2014

Related U.S. Application Data
(60) Provisional application No. 61/507,076, filed on Jul. 12, 2011.

(51) Int. Cl. A23G 9/44; A23C 9/133; B65D 85/816

(52) U.S. Cl. CPC A23G 9/44; B65D 85/816; A23C 9/133
USPC 426/86

(57) ABSTRACT

A yogurt smoothie kit for use in preparing yogurt smoothies, when combined with mixing liquid, is provided herein. The kit includes a container having an inner volume, an open top end, a closed bottom end, and a demarcation positioned between the top end and the bottom end, the inner volume divided by the demarcation into an upper volume above the demarcation and a lower volume below the demarcation. The kit further includes, inside the container, a plurality of frozen yogurt pellets, the frozen yogurt pellets each having at least milk proteins, milk fat, yogurt bacterial cultures, sugar, and a stabilizer mix.

### BACKGROUND

1. Field

The present disclosure relates generally to kits for yogurt smoothies, and more specifically to yogurt smoothie kits that include frozen yogurt-based pellets.

2. Description of Related Art

Frozen, or more precisely partially frozen, beverages are enjoyed by consumers, world-wide. Examples of frozen beverages include milk shakes, frozen cocktails, daiquiris, pina coladas, margaritas, milk shakes, frozen coffees, frozen lemonades, fruit smoothies and granitas. Typically, frozen beverages are served at temperatures at or near the freezing point of water, which imparts a desirable “iciness” to the beverage. In some instances, the frozen beverage may have both liquid water and dispersed crystals of ice intermixed throughout the beverage. This dispersion provides both the desirable temperature and mouth-feel profiles of the frozen beverage. For children, in particular, frozen beverages may be both desirable and nutritious, at the same time.

However, providing the “iciness” of frozen beverages may make them difficult to prepare: the frozen beverage cannot be nearly completely frozen (e.g., a popsicle), nearly completely liquid (e.g., a fully liquid beverage), or poorly dispersed (e.g., ice cubes in liquid). For example, certain frozen beverages, such as milk shakes, are often prepared by thoroughly mixing a fluid, such as milk, a frozen constituent, such as ice cream, and a flavoring, such as fruit or chocolate syrup. To obtain the rich, creamy mouth feel and slushy consistency of a milk shake, a lengthy and/or cumbersome blending of the ingredients is often required. Mechanical mixers capable of mixing hardened ice cream may need to be used, and the preparer must often assemble a variety of ingredients, typically requiring an effort that an average consumer finds undesirable. For other frozen beverages, such as granitas, specialized equipment, such as freezing machines, are necessary to freeze a liquid mixture in a controlled manner while mixing. Additionally, preparation may require relatively precise measurements of the ingredients to ensure that a proper balance of flavors and textures are achieved.

Frozen beverages that have been prepared in advance for later consumption, thereby ameliorating some of the difficulties of preparation, have met with resistance from the typical consumer. Often, consumers object to the deficiencies in flavor, mouth feel, creaminess, and overall icy refreshing quality. Consumers may also object to the limited shelf-life or the need for heating equipment (e.g., a microwave) to achieve the desired textures. Additionally, such pre-prepared beverages may be relatively heavy and difficult to transport, due to the inclusion of a high percentage of water.

U.S. Pat. No. 7,615,245 provides frozen pellets that may be used to make frozen beverages, when mixed with a liquid (e.g., milk). The resulting beverages may meet much of the consumer demand for a milk shake or ice cream shake type beverage. However, consumers also enjoy other types of frozen beverages, such as yogurt smoothies and fruit smoothies. Yogurt smoothies and fruit smoothies, in particular, are viewed as being nutritionally desirable as they may include live and active cultures (i.e., probiotics) to aid digestion and dietary fiber and vitamins. Notably, while yogurt smoothies and fruit smoothies share some ingredients with milk or ice cream shakes, they also include ingredients not found in milk or ice cream shakes and even the ingredients-in-common may be provided in substantially different proportions.

With respect to yogurt smoothies containing live and active cultures, probiotics and bacterial cultures present in yogurt are well-documented and known to provide intestinal health. Strains of lactobacillus and Bifidobacterium have been shown to contribute to the health of intestinal microflora when consumed in the diet.

Probiotics are microorganisms that are believed to improve health by maintaining a normal balance of microorganisms in the human intestines. They are contained in some food products and also are sold as nutritional supplements. Additionally researchers found consistent evidence that probiotics can benefit people who are taking antibiotics. Exemplary findings may be found in the May 9 2012 edition of the Journal of the American Medical Association.

In pre-made yogurt smoothie products, the quantity of live and active cultures decreases over time given the liquid state, resulting in a concurrent decrease in the associated healthful benefits. Typically it is necessary to obtain up to 10⁶ per gram of bacteria per finished product which can die off rapidly in a liquid state over the shelf life of a beverage.

The viability of frozen microorganism is known and cryogenic techniques have been used to store cultures and maintain viability in the frozen state, which may be more preferable and more stable than storage in a liquid state.

Accordingly, there remains a need for a frozen beverage, such as a yogurt smoothie or a fruit smoothie that can be readily and rapidly prepared, without the need for specialized equipment. In particular, there remains a need for a product that would allow consumers to readily and conveniently prepare a frozen beverage that is both nutritious and satisfying. Moreover, there remains a need for a product that would allow the preparation of a yogurt beverage having improved bacterial stability.

### BRIEF SUMMARY

In one embodiment, the present disclosure provides a yogurt smoothie kit for use in preparing yogurt smoothies, when combined with mixing liquid. The kit includes a container having an inner volume, an open top end, a closed bottom end, and a demarcation positioned between the top end and the bottom end, the inner volume divided by the demarcation into an upper volume above the demarcation and a lower volume below the demarcation. The kit further includes, inside the container, a plurality of frozen yogurt pellets, the frozen yogurt pellets each having at least milk proteins, milk fat, yogurt bacterial cultures, sugar, and a stabilizer mix. The plurality of frozen yogurt pellets in the kit have a combined mass, in grams, that is equal to between 0.090 and 0.275 times the volume of the lower volume of the container, in milliliters. Further, the plurality of frozen yogurt pellets in the kit have a combined fat content, in grams, that is equal to between 0.003 and 0.010 times the volume of the lower volume of the container, in milliliters. Additionally, the plurality of frozen yogurt pellets in the kit have a combined carbohydrate content, in grams, that is equal to between 0.020 and 0.065 times the volume of the lower volume, in milliliters.

In another embodiment, the preset disclosure provides a yogurt smoothie kit having improved microbial stability of a cryogenically frozen bacterial culture with the associated health benefits. This yogurt smoothie kit, when maintained in a frozen (rather than liquid) state leads to improved viability of cultures which is important to achieving associated health benefits. In the embodiment of the yogurt smoothie kit provided herein and the use thereof, the kit is combined with a liquid just prior to use, avoiding the potential of rapid bacterial die-off due to storage in a liquid medium. Thus, this combination of the frozen yogurt pellet with the liquid at the point of consumption in a container without the use of a blender or mixer delivers the benefit of improved bacterial viability in a convenient beverage form.

### DESCRIPTION OF THE FIGURES

FIG. 1 depicts an exemplary yogurt smoothie kit container.

FIG. 2 depicts an exemplary yogurt smoothie kit container with a cut-away showing frozen yogurt pellets intermixed with frozen fruit pieces.

### DETAILED DESCRIPTION

The following description sets forth exemplary methods, parameters and the like. It should be recognized, however, that such description is not intended as a limitation on the scope of the present disclosure but is instead provided as a description of exemplary embodiments.

In general, the present disclosure provides methods and articles of manufacture for preparing beverages, including frozen beverages, such as milk shakes. As used herein, a “frozen beverage” means a beverage, typically at a temperature range (upon preparation) of from about 5° F. to about 40° F., or from about 28° F. to about 36° F. The frozen beverage is typically capable of flowing under conditions of low to moderate shear stress. A frozen beverage can have a viscosity (upon preparation) of from about 100 to about 150 centipoises, e.g., from about 110 to 115 centipoises or from about 120 to about 135 centipoises in certain embodiments.

As described herein, frozen pellets containing milk, sweetener, and a stabilizer mix can be used to rapidly prepare frozen beverages, such as milk shakes or creamy fruit beverages. In certain cases, frozen pellets can contain milk, cream, a mixture of one or more sweeteners including inulin, and a stabilizer mix. A liquid is added to the frozen pellets, and after shaking, a frozen beverage is produced. Thickness of the beverage can be adjusted to consumer preference, by, for example, adding more liquid. Thus, beverages can be prepared that can be drunk (with or without a straw) or consumed with a spoon. In some embodiments, the methods and articles employ two sets of frozen pellets. In other embodiments, one set of frozen pellets is mixed with the appropriate liquid to result in the frozen beverage.

Also as described herein, frozen pellets may contain bacterial cultures, including live and active cultures, and cultured milk products. As used herein, such pellets may be referred to as frozen yogurt pellets. Frozen yogurt pellets may be include one or more of the ingredients described with respect to non-yogurt frozen pellets such as sweeteners, stabilizers, and the like. Frozen yogurt pellets may be combined with a liquid to form a frozen beverage, after shaking.

As further described, frozen yogurt pellets may be included in a kit for conveniently making a frozen beverage. Such a yogurt smoothie may include a pre-measured quantity of frozen yogurt pellets disposed in a container having a pre-designated volume for the addition of a fluid (e.g., water, milk, or fruit juice). The quantity and composition of the frozen yogurt pellet would have been selected to provide a shake having desirable properties such as nutritional composition, temperature, and mouth-feel after the addition of the designated volume of fluid.

### Frozen Pellets

The methods and articles described herein can employ a first set of frozen pellets, or first and second sets of frozen pellets, referred to herein as first frozen pellets and second frozen pellets.

The frozen pellets have a shape, size, volume, and surface area to allow efficient pellet break down upon manual mixing with an added liquid. Typically mixing is complete within 10 seconds to 2 minutes, or any value therebetween (e.g., about 15, 20, 30, 45, 60, 75, 90, or 105 seconds). The first and second frozen pellets may have, independently, any shape, size, volume, surface area, and color. For example, the pellets may be spheres, ovals, cubes, cylinders, rectangles, diamonds, or other novelty shapes (e.g., flowers, stars, faces), or mixtures of various shapes. Generally, the first frozen pellets and second frozen pellets are, independently, of relatively uniform size and shape. For example, the first frozen pellets may be spheres of a particular size, while the second frozen pellets may be cubes of a different size. Alternatively, the first and second frozen pellets may both be spheres of the same size. Typically, the frozen pellets may have a diameter of from about 1 mm to about 20 mm, or any value therebetween (e.g., about 2, 3, 4, 5, 6, 7, 8, 9, 10, 11, 12, 13, 14, 15, 16, 17, 18, or 19 mm). In certain embodiments, a pellet can have a diameter of from about 4 mm to about 10 mm. The first and second pellets may be the same color (e.g., first and second frozen pellets are white) or two different colors (e.g., first frozen pellets are white, while second frozen pellets are blue), or the pellets may be, independently, a mixture of colors (e.g., first frozen pellets are red and yellow; second frozen pellets are white and yellow).

The first frozen pellets or a combination of the first and second frozen pellets can be used to prepare frozen beverages. Thus, first frozen pellets may be used to prepare frozen beverages in two ways: 1) first frozen pellets may be mixed with an appropriate liquid to result in a frozen beverage; or 2) first frozen pellets may be combined with (e.g., mixed with) second frozen pellets and an appropriate liquid to result in a frozen beverage. Depending on the method chosen, the formulation and amount of first frozen pellets and the amount of liquid used to prepare the frozen beverage may vary, as discussed below.

First frozen pellets generally contribute to the creamy mouth feel and flavor of the frozen beverage. The first frozen pellets include a milk fluid, a sweetener, a flavoring, and a stabilizer mix. A cream fluid is also typically included in the first frozen pellets. In certain cases, a sweetener included in the first frozen pellets can include inulin and/or other fructo-oligosaccharides. Optional ingredients include buffers, fats, oils, proteins, colorants, acidulants, foaming agents, anti-foaming agents, cloudifiers, fiber sources, preservatives, antioxidants, masking agents, and nutritive additives.

Second frozen pellets can contribute to the icy slushy texture of the frozen beverages described herein. While not being bound by any theory, it is believed that the second frozen pellets have an ice crystal formation that is suitable for relatively easy break up upon mixing with the first frozen pellets and the added liquid. The second frozen pellets generally include a milk fluid, a sweetener, and a stabilizer mix. Optional ingredients as indicated above are also contemplated.

In certain embodiments, a first frozen pellet may be the only pellet needed. For example, in certain cases, a first frozen pellet can include a milk fluid, a cream fluid, a stabilizer mix, a sweetener including one or more fructo-oligosaccharides such as inulin, and a flavoring.

### Preparation of Frozen Pellets

To prepare the first or second frozen pellets, the ingredients are generally mixed in the appropriate amounts and heated, if necessary, to aid dispersion and solubilization of the ingredients (e.g., heated to from about 150° F. to about 190° F., such as about 185° F.). The mixture may be homogenized and/or treated with shear force. The mixture can be pasteurized, e.g., by FDA-approved methods, in continuous flow, multi-stage, or batch methods. If necessary, after pasteurization and/or homogenization, the mixture may be cooled, e.g., cooled to a temperature from between about 2° C. to about 20° C., such as about 4° C. to about 12.5° C. The cooled mixture can remain at the cooled temperature for an aging period, e.g., about 4 hours to about 24 hours. Aging may contribute to a favorable and homogeneous distribution of a stabilizer mix. Flavorings and/or sweeteners may be added prior to heating, after heating, or after cooling, particularly if the flavorings or sweeteners are volatile or heat-sensitive. Whipping or incorporating air into the mixture can increase the volume or overrun; however, overrun may not lead to optimal pellet quality upon freezing, and thus incorporating air to result in overrun is preferably avoided. Prior to freezing, the mixture can exhibit minimal overrun, e.g., less than about 102% overrun, or less than about 100% overrun. Overrun can be calculated by subtracting the weight of a mixture having air incorporated (e.g., by whipping) from the weight of the non-air-incorporated mixture, dividing by the weight of the air-incorporated mixture, and multiplying by 100.

The mixture can then be frozen. For example, the mixture can be frozen in appropriate molds to result in the desired shape and/or size of the pellets, or can be frozen, e.g., as a slab, and then cut into the appropriate shape and size. The mixture may be frozen by exposure to dry ice or liquid nitrogen or with the use of a freezer. In some embodiments, the mixture is frozen during pellet formation. For example, spherical pellets can be formed by allowing the mixture to drop (e.g., by gravity or positive pressure) into a source of liquid nitrogen. See also, e.g., methods disclosed in U.S. Pat. Nos. 5,126,156; 5,664,422; and 6,000,229. In certain embodiments, a freezer, e.g., a Frigoscandia Equipment FloFreeze® Individual Quick Freezer (IQF) may be used to prepare the frozen pellets (Frigoscandia Equipment, FMC Corp.). Alternatively, pellets could be sprayed to build up successive layers of various ingredients including water.

After freezing, the pellets can be coated. Coatings can aid in the free flow of the pellets relative to one another and/or a container, and can optionally contribute flavors, colors, or stability to the pellets. For example, a coating can be a carbohydrate, such as a cold swelling starch; a sweetener such as trehalose or sucralose; a defoamer, such as a mixture of 2% SAG 100 and 1% sodium citrate; a protein, such as sodium caseinate, or a fat.

After freezing, pellets can be hardened or tempered, at about −10° C. to about −30° C. (e.g., about −20° C.). Hardening or tempering can take place for any period of time, e.g. about 1 hr. to about 1 week, or longer. Aging and/or tempering can bring the pellets into a more stable condition vis-à-vis temperature fluctuations during distribution (e.g., favorable melting rate, favorable melting temperature).

The milk fluids for inclusion in the first or second frozen pellets include whole milk, skim milk, 1% milk, 2% milk, condensed milk, non-fat milk, soy milk, rice milk, oatmilk, buttermilk, and mixtures thereof. Reconstituted powdered milk may also be used. The milk fluid may be lactose-free. In some embodiments, whole milk is used as the milk fluid for first and/or the second frozen pellets.

Generally the milk fluid is about 25% to about 78% by weight of the first frozen pellets. As used herein, percentages by weight reflect the percentage of the appropriate ingredient in the mixture prior to freezing. For example, the milk fluid can be about 50% to about 60%, about 65% to about 75%, or about 38% to about 50% by weight of the first frozen pellets. In certain cases, the milk fluid is from about 68% to about 72% by weight of the first frozen pellets, or any value therebetween (e.g., about 69, 70, or 71%). Typically, the milk fluid is about 60% to about 85%, or about 80% to about 85% by weight of the second frozen pellets.

The cream fluid for inclusion in the first frozen pellets can have a fat content ranging from approximately 15% to 45%, including, for example, heavy cream, light cream, regular cream, and half and half. Reconstituted dry cream can also be used. The cream fluid may be lactose-free. The cream fluid generally contributes to the rich, creamy taste and mouth feel of the frozen beverages, e.g., milk shakes, of the present invention. In one embodiment, heavy cream (40% fat content) is used in the first frozen pellets.

The combined amount of the milk fluid and the cream fluid in the first frozen pellets can range from about 62% to about 92% by weight, or from about 80% to about 87% by weight. In other embodiments, the combined amount of the milk fluid and the cream fluid in the first frozen pellets can range from about 62% to about 78%, from about 68% to about 72%, or from about 82% to about 86% by weight. Typically, the total amount of milkfat in first or second frozen pellets ranges from about 4% to about 10%, or any value therebetween (e.g., about 5, 6, 7, 8, or 9%).

A stabilizer mix generally contributes to the rich mouth feel, body, viscosity, and stability of the frozen beverage. A stabilizer mix can include one or more of the following: a gum, an emulsifer, and a stabilizer. A stabilizer mix is generally provided in a range from about 0.15% to about 2% by weight of the first frozen pellets (e.g., about 0.20%, 0.25%, 0.30%, 0.35%, 0.40%, 0.45%, 0.50%, 0.55%, 0.60%, 0.65%, 0.70%, 0.75%, 0.80%, 0.85%, 0.90%, 0.95%, 1%, 1.1%, 1.2%, 1.3%, 1.4%, 1.5%, 1.6%, 1.7%, 1.8%, or 1.9%), and from about 0.2% to about 0.6% by weight of the second frozen pellets. In some embodiments, the stabilizer mix is provided in a range of from about 0.1% to about 0.4% by weight of the first frozen pellets (e.g., about 0.3%), and in a range of from about 0.3% to about 0.5% by weight of the second frozen pellets. In other embodiments, a stabilizer mix for first frozen pellets can be provided in a range of from about 0.6 to about 1%, or from about 1% to about 1.4% by weight. A stabilizer mix for use in the present invention can be commercially available (e.g., Daritech FR 102 (Degussa), which includes guar gum, carrageenan, and mono- and diglycerides; this stabilizer mix is standardized with dextrose. In other cases, a stabilizer mix can be prepared by including the appropriate gum, emulsifer, and/or stabilizer, e.g., either by mixing prior to addition to the other pellet ingredients or during mixing with the other pellet ingredients.

Gums for inclusion in a stabilizer mix can be selected to enhance the physical stability of the frozen beverage, e.g., from cream separation, whey separation, phase separation, syneresis, and protein coagulation. For example, gums can help emulsify fat and trap whey proteins, and provide suspension, viscosity, and body to the resultant frozen beverage. Gums included in the stabilizer mix for second frozen pellets also can contribute to the slushy quality of the frozen beverage by enhancing easy break up of the ice crystal formation in the second frozen pellets upon mixing with the added liquid.

Typical gums include carageenans, alginates, xanthan gum, cellulose gel, locust bean gum, gum tragacanth, gum karaya, gum arabic, gum ghatti, gelatin, pectin, guar gum, and tara gum, or mixtures thereof. In some embodiments, carageenans, carageenan and guar gum, or carageenans and gelatin, can be used in the stabilizer mix of the first frozen pellets. Carageenan refers to a family of food grade polysaccharides obtained from red seaweeds. Carageenans for use in the present invention can include kappa, lambda, and iota carageenans, or any mixture thereof. Carageenans may be particularly useful for frozen beverages containing dairy products or fluids. In certain embodiments, gelatin is used alone, or in combination with carageenans, in the second frozen pellets. Blends of gums may be useful for frozen beverages comprising fruit juices or concentrates. Gums, including carageenans, are available from FMC (Princeton, N.J.); and Rousselot (DuBuque, Iowa).

Emulsifiers included in a stabilizer mix can help emulsify fats and contribute to the stability, consistency, and mouth feel of the frozen beverage. Food grade emulsifiers are generally known in the art. Nonlimiting typical examples of emulsifiers include distilled monoglycerides, mono- and diglycerides, diacetyl tartaric acid esters of mono- and diglycerides (DATEM), lecithin, emulsifying starches (e.g., octenylsuccinate anhydride starch), tapioca starches, cold swelling starches, modified lecithin, polysorbate 60 or 80, sodium stearyl lactylate, propylene glycol monostearate, succinylated mono- and diglycerides, acetylated mono- and diglycerides, propylene glycol mono- and diesters of fatty acids, polyglycerol esters of fatty acids, lactylic esters of fatty acids, glyceryl monosterate, propylene glycol monopalmitate, glycerol lactopalmitate and glycerol lactostearate, and mixtures thereof. Emulsifiers are available commercially through, e.g., FMC Biopolymer (Philadelphia, Pa.), Central Soya (Fort Wayne, Ind.), Danisco (Copenhagen, Denmark); CPKelco (San Diego, Calif.), TIC (Belcamp, Md.).

Stabilizers included in a stabilizer mix can contribute to texture, mouth feel, and ice crystal size control. Stabilizers suitable for inclusion in food products are commercially available and known in the art. Typical examples include cellulose; gelling agents; whipping agents, e.g., soy whipping agents; and antioxidants.

The first and second frozen pellets also include a sweetener. Sweeteners can contribute to the flavor and sweetness of the frozen beverages, as well as function as bulking, stability, and melting point depressants. The amount of sweetener used will vary with, e.g., the flavoring used, consumer preference, caloric content desired, etc. Generally, the sweetener is included in an amount from about 10% to about 25% by weight of the first frozen pellets, or from about 12% to about 15%. For second frozen pellets, the sweetener is typically included in an amount from about 10% to about 20%, or from about 14% to about 17% by weight.

The sweetener can be nutritive or nonnutritive. Examples of sweeteners for use in the present invention include sugar, trehalose, sucrose, sucralose, maltodextrin, corn syrup, corn syrup solids, high maltose syrups, sugar solids, fructose, lactose, dextrose, fructo-oligosaccharides such as inulin, acesulfame potassium, neotame, saccharin, aspartame, high fructose corn syrup, sorbitol, mannitol, xylitol, erythritol, maltitol, isomaltitol, lactitol, and mixtures thereof.

Trehalose is a unique, naturally occurring disaccharide containing two glucose molecules bound in an α, α-1, 1 linkage. This structure results in a chemically stable, non-reducing sugar. While not being bound by any theory, trehalose is believed to contribute to desirable freeze-thaw properties of the frozen beverages. Trehalose is 45% as sweet as sucrose when compared to a 10% sucrose solution. In addition, the taste profile is nicely balanced, and the mild sweetness of trehalose can allow other flavors in the frozen beverages to be enhanced.

Sucralose is a high-intensity sugar substitute, which is sold under the name Splenda®. It is non-caloric and about 600 times sweeter than sucrose (white table sugar), although it can vary from 320 to 1,000 times sweeter, depending on the food application. The white crystalline powder tastes like sugar, but is more intense in its sweetness. Other high intensity sugar substitutes include aspartame, saccharin, acesulfame potassium, and neotame.

Fructo-oligosaccharide fibers, such as inulin, belong to the fructan group of oligo- and polysaccharides. They are composed of linear chains of fructose units linked by P 2-1 bonds and are generally terminated by a glucose unit. Fructo-oligosaccharides may promote the growth of beneficial Bifidobacteria in the lower gut and may help increase the absorption of dietary calcium. While not being bound by any theory, the addition of inulin and/or fructo-oligosaccharide fibers may improve beverage stability, slow melting, and improve the mouth-feel, flavor retention, and creaminess of a frozen beverage.

Maltodextrins are mixtures of glucose polymers produced by the controlled depolymerization of corn starch. They are most often categorized by dextrose equivalence, which is a measure of reducing power as compared to a dextrose standard of 100.

In some embodiments of the first or second frozen pellets, trehalose, or a combination of trehalose and sucralose, or a mixture of trehalose, corn syrup, and sucralose, are used as a sweetener. In other embodiments, maltodextrin, or a combination of maltodextrin and sugar solids (e.g., sucrose), or a combination of maltodextrin, sugar solids, and sucralose are used. In yet other embodiments, a mixture of sucralose, sugar, corn syrup and corn syrup solids are used, or a mixture of sucralose, corn syrup solids, corn syrup, inulin, and maltodextrin are used. Sweeteners are commercially available, e.g., through Cargill Inc. (Wayzata, Minn.) and McNeil Specialty (Fort Washington, Pa.).

First frozen pellets also include one or more flavorings. The flavoring can be artificial or natural. The amount of the flavoring will depend on the flavoring itself, sweetener content, and consumer preference. Generally the flavoring will be present in an amount of from about 0.1% to about 2% by weight of the first frozen pellets. Suitable flavorings include citrus and non-citrus fruit flavors; spices; herbs; botanicals; chocolate, cocoa, or chocolate liquor; coffee; flavorings obtained from vanilla beans; nut extracts; liqueurs and liqueur extracts; fruit brandy distillates; aromatic chemicals, imitation flavors; and concentrates, extracts, or essences of any of the same. For example, pure vanilla or ethyl vanillin may be used, or a combination of the two, to prepare a vanilla milkshake. Flavorings may also be optionally included in second frozen pellets, typically in the same range as for the first frozen pellets. Flavorings are available commercially from, e.g., Rhodia USA (Cranbury, N.J.); IFF (South Brunswick, N.J.); Wild Flavors, Inc. (Erlanger, Ky.); Silesia Flavors, Inc. (Hoffman Estates, Ill.), Chr. Hansen (Milkwaukee, Wis.), and Firmenisch (Princeton, N.J.).

Additional optional ingredients may also be incorporated into the first or second frozen pellets as needed or desired to result in a frozen beverage of a particular mouth feel, creaminess, stability, and consistency. Examples of optional ingredients for inclusion in a frozen beverage are generally known in the art and include buffers, fats, fiber sources, cloudifiers, proteins, colorants, masking agents, preservatives, acidulants, foaming agents, antifoaming agents, and nutritive additives.

Buffers to adjust the pH of the frozen beverage can also be included in the first or second frozen pellets. Typically, beverages can have a pH of about 2.0 to 6.9. For example, the pH of a milk shake can range from about 6.5 to about 7.2, or from about 6.6 to about 6.9. Other frozen beverages can have lower pHs. Buffers should be food grade. Typical buffers include orthophosphate buffers such as sodium phosphate, potassium phosphate. Other buffers include sodium citrate and potassium citrate. The buffer should be included in an amount to achieve the desired pH of the frozen beverage, and will depend on the end product and the liquid selected (e.g., juice vs. milk).

Food grade natural or artificial colorants may optionally be included in the frozen pellets. These colorants may be selected from those generally known and available in the art, including synthetic colors (e.g., azo dyes, triphenylmethanes, xanthenes, quinines, and indigoids), caramel color, titanium dioxide, red #3, red #40, blue #1, and yellow #5. Natural coloring agents such as beet juice (beetred), carmine, curcumin, lutein, carrot juice, berry juices, spice extractives (turmeric, annatto and/or paprika), and carotenoids may also be used. The type and amount of colorant selected will depend on the end product and consumer preference. For example, vanilla frozen beverages can range from a white or cream color to a more yellow color. The amount of colorant, if used, will typically range from about 0.005% to about 0.01% by weight of the frozen pellets. Colorants are available from, e.g., Wild Flavors, Inc. (Erlanger, Ky.), McCormick Flavors (Hunt Valley, Md.), CHR Hansen (Milwaukee, Wis.), RFI Ingredients (Blauvelt, N.Y.), and Warner-Jenkinson (St. Louis, Mo.).

Fats may also optionally be included in the first or second frozen pellets. As used herein, “fat” includes both liquid oils and solid or semi-solid fats. Fats can contribute to a creamy feeling on the tongue and impart melt resistance to the frozen beverage. Suitable fats include, without limitation, partially or fully hydrogenated vegetable oils such as cotton seed oil, soybean oil, corn oil, sunflower oil, palm oil, canola oil, palm kernel oil, peanut oil, MCT oil, rice oil, safflower oil, coconut oil, rape seed oil, and their mid- and high-oleic counterparts; or any combination thereof. Animal fats such as butter fat may also be used. The amount of fat included will depend on the end-product, but generally ranges from about 0% to about 20% by weight of the frozen pellets, or from about 0% to about 10%. Fats and oils are available commercially from, e.g., Cargill, Inc. (Wayzata, Minn.), Fuji Vegetable Oil (White Plains, N.Y.), ADM (Decatur, Ill.), and Loders-Croklaan (Channahon, Ill.).

Fiber sources can also be optionally included in first or second frozen pellets. Both soluble and insoluble fiber sources can be used to increase total dietary fiber content; to add mouth-feel, texture, and body; to stabilize a pellet system; to enhance flavor; and to replace fat (e.g. as a fat mimetic). Examples of fiber sources include arabinogalactan, pectin, beta glucan, inulin, fructooligosaccharides, maltodextrin, resistant starch, psyllium, CMC, microcrystalline cellulose, alginate, gum Arabic, partially hydrolyzed guar gum, locust bean gum, carrageenan, xanthan gum, and oat fibers. The amount of fiber source will vary depending on the desired properties in the end-product, but typically can range from about 0.1% to about 10% by weight of a frozen pellet, or any value therebetween (about 0.5%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5% by weight). In certain cases, a fiber source can range from about 1% to about 4% by weight of a frozen pellet.

Proteins or peptides can be included in the frozen pellets, e.g., for nutritive purposes and/or for their contribution to the consistency, whipping property, smoothness, mouth feel, and stability of the frozen beverages. Typical proteins include caseins, soy proteins (e.g., soy protein isolate or hydrolysate), albumin, non-fat milk solids, milk proteins, whey protein, rice protein, wheat protein, oat protein, and mixtures thereof. Protein hydrolysates may also be used. See, e.g., U.S. Pat. Nos. 5,024,849 and 6,287,616. The protein may be supplied as is, or may be a component of, e.g., the milk or cream fluids described previously. Proteins are available from, e.g., New Zealand Milk Products (Lemoyne, Pa.); Land O'Lakes (St. Paul, Minn.); Cargill, Inc. (Wayzata, Minn.); and DuPont Protein Technologies (St. Paul, Minn.).

Preservatives can be included as some ingredients tend to react and change over time. Examples include potassium sorbate, calcium sorbate, and sodium benzoate. Masking agents can be included to mask artificial sweeteners or off-flavors, such as grassy, beany, or chalky flavors found in some nutritional ingredients. Acidulants can provide sharpness and bite, and also contribute to preservation. Citric, malic, fumaric, ascorbic, lactic, phosphoric, and tartaric acid can be used as acidulants. Acidulants are available from Cargill, Inc. (Wayzata, Minn.) and ADM (Decatur, Ill.).

Frozen pellets may also contain one or more nutritive and/or health additives, e.g., to promote weight gain or loss, cardiovascular health, pediatric health, geriatric health, women's health, etc. Suitable examples of nutritive and/or health additives, include proteins (e.g., as described above); fats; carbohydrates; triglycerides; fiber (e.g., soy fiber); amino acids (e.g., histidine, isoleucine, leucine, lysine, methionine, phenylalanine, threonine, tryptophan, valine, alanine, arginine, aspartic acid, cystine, glutamic acid, glycine, proline, serine, tyrosine); L-carnitine, taurine, m-inositol; nucleic acids; fatty acids (omega-3 fatty acids, such as EPA and DHA; polyunsaturated, monounsaturated, and saturated fatty acids, such as linolenic acid, alpha-linolenic, caprylic acid, capric acid, lauric acid, myristic acid, palmitic acid, stearic acid, oleic acid, and arachidic acid); plant phytosterols and plant phytostanols; isoflavones (e.g., daidzein, genistein, glycitein, daidzin, genistin, glycitin, 6″-O-acetyldaidzin, 6″-O-acetylgenistin, 6″-O-acetylglycitin, 6″-O-malonyldaidzin, 6″-O-malonylgenistin, and 6″-O-malonylglycitin); green tea extracts; vitamins (e.g., vitamins A, D, E, K, C, folic acid, thiamin, riboflavin, vitamins B6 and B12, niacin, choline, biotin, panthothenic acid); beta-carotene; phylloquinone; niacinamide; minerals (sodium, potassium, chloride, calcium, phosphorus, magnesium, iodine, manganese, copper, zinc, iron, selenium, chromium, molybdenum); glucosamine sulfate; chondroitin sulfate; hyaluronic acid; s-adenosyl methionine; milk thistle; dandelion, burdock, ginseng, ginger, ginko bilboa, caffeine, guarana, inulin, zeaxanthin, rosmarinic acid, lycopene, lutein, grape extracts, flax seed, and salts, including salts of the compounds described previously; and derivatives of the compounds described previously. Vitamins and minerals are available from e.g., Roche Vitamins, Inc. (Parsippany, N.J.); phytonutrients and carbohydrates are available from Cargill, Inc. (Wayzata, Minn.).

### Frozen Yogurt Pellets and Preparation of Frozen Yogurt Pellets

The methods and articles (such as kits) described herein may also employ frozen yogurt pellets. Frozen yogurt pellets may have the same general properties, including physical properties (e.g., pellet size, shape, and melting profile) and compositional properties (e.g., ingredients, additives, and inclusions) as discussed herein with respect to (non-yogurt) frozen pellets. In particular, the frozen yogurt pellets may include a stabilizer to improve the mouth-feel, body, viscosity, and/or stability of a frozen beverage made using the frozen yogurt pellets. Further, frozen yogurt pellets may be prepared according to the same general manner, and using the same equipment, as discussed above with respect to (non-yogurt) frozen pellets.

The frozen yogurt pellets described herein may include live and active yogurt bacterial cultures (i.e., lactic acid-producing bacteria) such as Lactobacillus delbrueckii subsp. bulgaricus, Streptococcus salivarius subsp. thermophilus, Lactobacillus acidophilus, bifidobacteria, Bifidobacterium animalis subsp. lactis, and Lactobacillus casei. Alternatively, or in addition to live and active cultures, the frozen yogurt pellets may include cultured milk products (e.g., cultured milk protein) resulting from a bacterial culturing process.

Notably, the inclusion of yogurt cultures and/or cultured milk products allows for the preparation of frozen beverages having a desirable mouth-feel without the need for a high fat content. In certain embodiments of frozen yogurt pellets, a lesser quantity of frozen yogurt pellets may impart a mouth-feel that is substantially equivalent to a greater quantity of a (non-yogurt) frozen pellet.

### Methods of Preparing Frozen Beverages

To prepare frozen beverages, the first frozen pellets, or first and second frozen pellets, are provided in the appropriate amount and mixed with a liquid for a time sufficient to result in a substantially homogeneous frozen beverage. By “substantially homogeneous” it is meant that the frozen beverage does not exhibit significantly undissolved first and/or second frozen pellets, and a drinkable beverage product is obtained. For example, preferably the frozen beverage has less than 40% of the volume of any individual pellet remaining after mixing, or less than 20%, or less than 10%, or less than 5%. If first and second frozen pellets are used to prepare a frozen beverage, first frozen pellets are usually provided in an amount from about 60% to about 70% by weight of the second frozen pellets. Mixing can be achieved by manual means, such as by shaking, stirring, or blending (e.g., by hand shaking in a shaker or by stirring or blending with a utensil such as a whisk or a spoon). Typically, the frozen beverage can be prepared by manually shaking the first frozen pellets, or first and second frozen pellets, with the liquid in an appropriate container. Generally, the mixing occurs for a time from about 10 seconds to about 2 minutes, or any value therebetween, e.g., from about 10 seconds to about 20 seconds, or from about 25 seconds to 1 minute. In some embodiments, mixing is complete in about 30 seconds. Alternatively, hand-held immersion blenders, upright blenders, and mechanical shakers are also suitable methods for mixing.

During mixing of the frozen pellets with the liquid, the pellets lose their pellet shape and size and a substantially homogeneous fluid frozen beverage is obtained. As described previously, a fluid beverage is capable of flowing under low or moderate shear stress, although it need not flow under conditions of no shear stress. Thus, the frozen beverages of the present invention may exhibit a relatively thick, nonflowing property while standing, but can be drunk through a straw, an example of a low shear stress.

Typical examples of mixing liquids include, without limitation, water, tea (e.g., green tea; chai tea), coffee, cocoa, whole milk, skim milk, 1% milk, 2% milk, chocolate milk, nonfat milk, heavy cream, light cream, regular cream, half and half, soy milk, rice milk, oatmilk, alcoholic beverages, carbonated and uncarbonated beverages, buttermilk, juices (e.g., citrus and non-citrus fruit juices or vegetable juices), yogurt juice, and mixtures thereof. In some embodiments, fruit juices or juice concentrates from orange, grapefruit, raspberry, cranberry, blackberry, apple, pear, lemon, mango, lime, peach, plum, strawberry, cherry, or blueberry fruits, or vegetable juices or juice concentrates from tomato, carrot, green pepper, grasses, or herbs can be used as a mixing liquid or in combination with another mixing liquid such as milk. Depending on the liquid chosen, a variety of beverages will result. For example, use of coffee can result in a frozen cappuccino-type product, while a fruit juice or fruit juice concentrate can produce a fruit smoothie type-product. Carbonated beverages such as root beer can produce a float-type product.

The liquid can be provided in an article of manufacture containing the frozen pellets, e.g., in an appropriate amount for mixing, or can be provided by the consumer. For example, an article of manufacture can include a container containing therein the appropriate liquid, e.g., a juice box or bag or a milk carton. Typically the liquid is provided at a temperature from about room temperature to about 40° F.

If first frozen pellets are used, the first frozen pellets are provided in an amount of from about 50% to about 125% by weight of the liquid, or any value therebetween (e.g., about 60%, 70%, 80%, 90%, 100%, 110%, or 120%). In certain embodiments, first frozen pellets can be provided from about 60% to about 70% by weight of the liquid. For example, 80 g of first frozen pellets may be mixed with 120 g of liquid. In other embodiments, the first frozen pellets and the liquid are provided in equal amounts. For example, 100 g of first frozen pellets may be mixed with 100 g of the liquid. In embodiments employing first and second frozen pellets, the liquid is generally provided in an amount of from about 50% to about 150% by weight of the combined weight of the first and second frozen pellets. In certain embodiments, the liquid is provided in an amount from about 70% to about 90% by weight of the combined weight of the first and second frozen pellets. For example, 50 g of first frozen pellets, 75 g of second frozen pellets, and 100 g of liquid may be mixed to result in a frozen beverage. As one of skill in the art will recognize, the consumer may adjust the amounts of the liquid to result in a thinner or thicker consistency beverage as desired.

The container for mixing can be made of ingredients such as plastic, metal, or glass. Typically, the container is an appropriate size and shape to promote efficient mixing of the pellets with the liquid. For example, the container should have an appropriate head space above the pellets and liquid for efficient mixing. Thus, the container may incorporate a head space of about 20% to about 150% of the combined volume of the first and second frozen pellets and the liquid. In addition, the container may be appropriately contoured and/or contain internal projections to promote mixing.

The container may include a cover, and the cover may include an opening for, e.g., a straw or spoon. In one embodiment, a shaker (e.g., a shaker similar to a martini shaker) is used as the container. The container may have one or more lines to indicate single and/or multiple serving size fill points for the pellets and/or liquid. A container can have a positive closure so that minimal spillage occurs during shaking. A container can have freeze-thaw resilience and durability. In some cases, a container may provide increased insulation of the pellets. For example, a foam label may provide increased protection from freeze-thaw cycles in the distribution chain. A container can contain therein an appropriate amount (e.g., single or multiple serving) of the frozen pellets. The consumer can then add the desired liquid and mix the pellets with the liquid to result in the frozen beverage.

The method can also include providing flavoring particulates, such as fruit (e.g., bananas, strawberries, blueberries, peaches, pears, plums, cherries, blackberries, apples, oranges) and/or confections (candy, cookies, cake, sprinkles, chocolate flakes, etc.). The flavoring particulates can vary in size, and can in some case be whole fruit (e.g., blueberries) or whole candies (e.g., M&M's®). The flavoring particulates can be provided prior to mixing of the frozen pellets with the liquid. For example, fruit particulates, such as minced strawberries, may be added to the frozen pellets in the container. After addition of the liquid and appropriate mixing, a frozen beverage with the fruit particulates distributed throughout is obtained. Alternatively, the flavoring particulates may be provided after mixing of the frozen pellets with the liquid. For example, cookie bits may be sprinkled on top of the resultant frozen beverage. The flavoring particulates may be included in an article of manufacture containing frozen pellets or can be provided by the consumer.

Similarly, the method can also include providing nutritive and/or health additives. Suitable nutritive and health additives are described above. The nutritive and/or health additives can be provided prior to mixing. For example, soy protein isolate can be added to the frozen pellets in the container, and after adding liquid and mixing, a frozen beverage containing soy protein isolate is obtained. Alternatively, the nutritive and/or health additives may be added after mixing of the pellets with the liquid, such as by sprinkling on top of the frozen beverage or by mixing into the frozen beverage with a spoon.

In certain embodiments, flavoring particulates or nutritive/health additives may be provided as third frozen pellets. For example, fruit or candy may be frozen and formed into third frozen pellets. The third frozen pellets may optionally include a milk fluid, a gum, and a sweetener. If a milk fluid, gum, or sweetener is included, the third frozen pellets will typically include the ingredient in similar proportions to the second frozen pellets.

### Methods of Preparing Yogurt Smoothies Using Frozen Yogurt Pellets

To prepare a yogurt smoothie frozen beverage, an appropriate amount of frozen yogurt pellets is mixed with a liquid for a time sufficient to result in a substantially homogenous yogurt smoothie, as described above with respect to (non-yogurt) frozen pellets. For example, similar mixing liquids and/or mixing containers may be selected for use with frozen yogurt pellets or (non-yogurt) frozen pellets.

Typically, a lesser weight/mass of frozen yogurt pellets are used with a given volume of liquid, as compared to (non-yogurt) frozen pellets. The cultured milk products found in frozen yogurt pellets may provide a frozen beverage mouth-feel that is substantially greater than in the frozen beverage mouth-feel resulting from an equivalent quantity of (non-yogurt) frozen pellets. Further, consumers typically prefer lower-calorie content in yogurt smoothies, which may be looked at as a healthful alternative to milk and ice cream shakes. Accordingly, frozen yogurt pellets are provided in a weight/mass, measured in grams, from about 0.090 times to about 0.275 times the volume of the finished yogurt smoothie, measured in milliliters. For example, the gram mass of the frozen yogurt pellets may be from 0.100 times, 0.150 times, 0.200 times, or 0.250 times the milliliter volume of the finished yogurt smoothie. Preferred gram mass ranges may be 0.100 to 0.270 times, 0.150 to 0.200 times, or approximately 0.180 times the milliliter volume of the finished yogurt smoothie.

As an alternative to, or in combination with, the provision of frozen yogurt pellets by mass, the quantity of frozen yogurt pellets may be selected to provide a yogurt smoothie having a pre-selected nutritional content. For example, frozen yogurt pellets may be provide in a sufficient quantity so that the combined fat content of the quantity of frozen yogurt pellets, in grams, is from about 0.003 times to about 0.010 times the volume of the finished yogurt smoothie, measured in milliliters. For example, the gram mass of the fats in the frozen yogurt pellets may be from 0.005 times, 0.07 times, or 0.009 times the milliliter volume of the finished yogurt smoothie, in milliliters. Preferred gram mass fat ranges may be 0.004 to 0.008 times, 0.005 to 0.007 times, or about 0.006 times the milliliter volume of the finished yogurt smoothie, measured in milliliters.

Alternatively, frozen yogurt pellets are provide in a sufficient quantity so that the combined carbohydrate content of the quantity of frozen yogurt pellets, in grams, is from about 0.020 times to about 0.065 times the volume of the finished yogurt smoothie, measured in milliliters. For example, the gram mass of carbohydrates in the frozen yogurt pellets may be from 0.025 times, 0.030 times, 0.040 times, 0.050, or 0.060 times the milliliter volume of the mixing liquid. Preferred gram mass carbohydrate ranges may be 0.025 to 0.060 times, 0.030 to 0.055 times, 0.035 to 0.050, or about 0.040 times the milliliter volume of the finished yogurt smoothie, measured in milliliters.

### Articles of Manufacture for Preparing Frozen Beverages

The present disclosure provides articles of manufacture for preparing frozen beverages. Articles of manufacture generally include the appropriate pellets for preparing the frozen beverage. If first and second frozen pellets are used, first frozen pellets can be provided in an amount from about 60% to about 70% by weight of the second frozen pellets. The pellets can be included “as is” inside the container. For example, if first and second pellets are used, the container may contain a mixture of both pellets. Alternatively, the pellets may be packaged. For example, the pellets may be in foil or plastic bags, pouches, or cups. The packaging may be vacuum-sealed or not. The pellet packages may be present inside a container, in an article alongside a container, or provided separately from the container. The article of manufacture can include an amount of the frozen pellets to prepare single or multiple servings of the frozen beverage. A single serving of a frozen beverage will typically range from about 200 mL to about 400 mL Multiple servings may be some multiple (e.g., 2×, 3×, 4×) of the single serving.

The articles of manufacture can include a container, as described above, for preparing the frozen beverage. In addition, the articles of manufacture can contain instructions for preparing frozen beverages. Typically, the instructions indicate that the preparer can mix the frozen pellets with an appropriate amount of a liquid for a time sufficient to result in the frozen beverage. Finally, the article of manufacture can include additional items, e.g., utensils, such as spoons or straws; the liquid for mixing; optional ingredients, as described previously; flavoring particulates; or third frozen pellets.

### Articles of Manufacture (Kits) for Preparing Yogurt Smoothies

The present disclosure provides articles of manufacture, also referred to as kits, for preparing yogurt smoothies. Such kits generally include a pre-determined quantity of frozen yogurt pellets provided in a container configured to serve as a container for storage, mixing, and serving.

In one embodiment of a yogurt smoothie kit, the container is a substantially-cylindrical container having an open top end and closed bottom end, with a defined inner volume. The container may include a demarcation that divides the inner volume into an upper volume above the demarcation and lower volume below the demarcation. Thus, the demarcation provides a visual indicator of the volume of mixing liquid to be added. That is, a volume of liquid sufficient to fill the lower volume, when combined with the consumable components of the kit (e.g., frozen yogurt pellets). The consumable components of the kit will, of course, occupy a percentage of the volume of the finished yogurt smoothie, once mixed with the mixing liquid. The volume occupied will depend on the quantity and composition of the consumable components. In some embodiments, the volume of mixing liquid required to fill the inner volume (i.e., reach the demarcation) is approximately 0.310 to 0.930 times the volume of the inner volume. For example, a container with a specific quantity of consumable components and an inner volume of approximately 300 mL may require approximately 190 mL of mixing fluid to fill the inner volume. In some embodiments, the lower volume may range from 100 mL to 400 mL, for a single serving container.

The demarcation may be visual mark (such as a line) placed on the inside or the outside (in the case of a container that is transparent or translucent) of the container. Alternatively, the demarcation may be printed on a label or sleeve that is to be attached to the container. In one embodiment, the demarcation is a transparent window in an otherwise opaque sleeve that is wrapped around the container. In such an embodiment of a demarcation, the volume below the bottom of the demarcation window is understood to be lower volume of the container.

The upper volume provides an appropriate amount of head space for efficient mixing, after the addition of liquid. In some embodiments, the upper volume may have a volume from 0.15 times to 0.6 times the volume of the lower volume, to provide sufficient head space for mixing.

In addition to the container, the kit further includes a plurality of frozen yogurt pellets with the combined mass of the plurality of pellets being based on the size of the lower volume (i.e., approximately the volume of the finished yogurt smoothie). For example, the gram mass of frozen yogurt pellets is approximately equal to 0.090 to 0.275 times the volume of the lower volume, in milliliters. Thus, a kit with a container having a lower volume of 300 mL (approximately 10.5 fluid ounces) may include from approximately 30 grams to 90 grams of frozen yogurt pellets, depending on the composition of the frozen yogurt pellets and the desired final composition of a yogurt smoothie made using the kit. By apportioning the quantity of frozen yogurt pellets according to the anticipated volume of finished yogurt smoothie, the final composition and qualities of the finished yogurt smoothie is maintained in a desired range.

In a preferred embodiment of a yogurt smoothie kit, the kit further includes a plurality of frozen fruit pieces, in addition to frozen yogurt pellets. For a yogurt smoothie prepared using only frozen yogurt pellets, the pellets must serve at least two purposes: 1) they must contribute the shake components not already present in the mixing fluid, and 2) they must act as heat sinks to absorb the heat from the mixing fluid and thereby provide the desired overall temperature of the resulting smoothie. Importantly, the frozen yogurt pellets must do so while still substantially dissolving. Thus, it may be difficult to achieve a desired balance between flavor, nutritional content, mouth-feel, and final beverage temperature. For example, use of high fat-content frozen yogurt pellets may contribute to mouth-feel and flavor, but may result in an undesired nutritional profile.

The addition of frozen fruit pieces allows at least a portion of the heat absorption function to be off-loaded from the frozen yogurt pellets. Notably, the fruit pieces are also generally nutritionally favored by consumers, as they are typically low in fat and may contain dietary fiber and desired nutrients. In embodiments of kits including frozen fruit pieces, the quantity and composition of the frozen yogurt pieces may be selected with more of a focus on achieving a desired nutritional profile (e.g., low fat) and a desired pellet dissolution profile. The frozen fruit pieces may be prepared from any commercially-available fruit such as strawberry, banana, blueberry, peach, apple, pineapple, mango, orange, or combinations of available fruits.

In a preferred embodiment of a yogurt smoothie kit having frozen fruit pieces and frozen yogurt pellets, the combined gram mass of frozen fruit pieces is approximately equal to 0.090 to 0.275 times the volume of the lower volume, in milliliters. For example, the gram mass of the frozen fruit pieces may be from 0.100 times, 0.150 times, 0.200 times, or 0.250 times the milliliter volume of the lower volume (i.e., approximately the finished yogurt smoothie volume). Preferred gram mass ranges may be 0.100 to 0.270 times, 0.150 to 0.200 times, or approximately 0.180 times the milliliter volume of the lower volume. Thus, a kit with a container having a lower volume of 300 mL (approximately 10.5 fluid ounces) may include from approximately 30 grams to 90 grams of frozen fruit pieces, depending on the desired final composition of a yogurt smoothie made using the kit. In one preferred embodiment, the gram mass of the frozen yogurt pellets is approximately equal to the gram mass of the frozen fruit pieces. Though, the ratio of frozen yogurt pellets to frozen fruit pieces may be adjusted depending on the composition of the frozen yogurt pellets and the desired final composition of a yogurt smoothie made using the kit.

As described herein, the design and make-up of a yogurt smoothie kit is typically more focused on the properties of the resulting finished yogurt smoothie, rather than the properties of the frozen yogurt pellets, which are not primarily intended for direct consumption. Notably, this is a significant different from frozen pellets intended for direct consumption. In one embodiment of a yogurt smoothie kit containing frozen fruit pieces, the composition or quantity of the frozen yogurt pellets may be adjusted to provide a desired final finished shake nutritional profile. For example, the frozen yogurt pellets and frozen fruit pieces may be selected to provide a combined carbohydrate gram mass that is equal to about 0.027 to 0.082 times the volume of the lower volume of the container, in milliliters. Alternatively, the frozen yogurt pellets and frozen fruit pieces may be selected to provide a combined dietary fiber gram mass that is equal to about 0.007 to 0.025 times the volume of the lower volume of the container, in milliliters.

In another embodiment of a yogurt smoothie kit, the kit may include two types of frozen pellets that are different, with at least one type of pellet being a frozen yogurt pellet. For example, the kit may include a (non-yogurt) first frozen pellet or (non-yogurt) second frozen pellet, as described herein. Alternatively, the kit may include two types of frozen yogurt pellets having different compositions and/or sizes and shapes.

Since the design and make-up of a yogurt smoothie kit may be more focused on the properties of the resulting finished yogurt smoothie, the properties and proportions of the consumable kit components, such as frozen yogurt pellets and frozen fruit pieces, may be tailored towards a specific type of mixing liquid. For example, the composition of the kit may be prepared as a kit for intended use with water, fruit juice, or whole milk as a mixing liquid. Thus, even when a substantially similar finished yogurt smoothie is intended, the composition of the consumable kit components may differ substantially, based on the expected contribution of the mixing liquid. In one embodiment of a kit intended for use with orange juice (which typically has a sugar concentration of approximately 0.085 g/ml), the soluble sugar content of the consumable kit components are selected to provide a finished yogurt smoothie having a Brix value ranging from about 8° Bx to about 18° Bx, taking into account the expected soluble sugar contribution from the orange juice. If a similar Brix range was desired for a finished yogurt smoothie using a kit intended for mixing with water, the soluble sugar contribution from the consumable kit components (e.g., frozen yogurt pellets and frozen fruit pellets) would be higher, as compared to the kit for use with orange juice. The increase may be affected by, for example, by an increase in the soluble sugar concentration in the frozen yogurt pellets or by an increase in the overall quantity of frozen yogurt pellets. In preferred embodiments, the Brix range of the finished shake include Brix ranges of 10 to 14° Bx, 11 to 13° Bx, and about 12° Bx.

Other desired finished yogurt properties that may dictate the properties and proportions of the consumable kit components include finished shake caloric content, fat content, viscosity, temperature, volume, and live and active bacterial culture content.

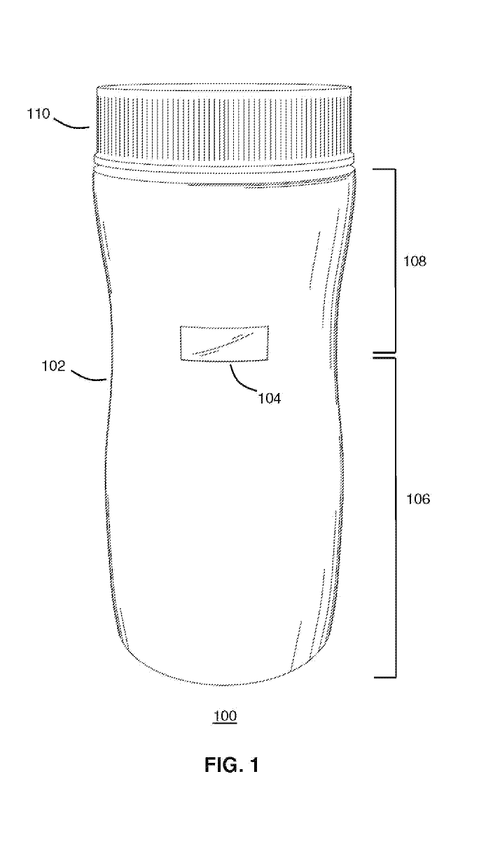

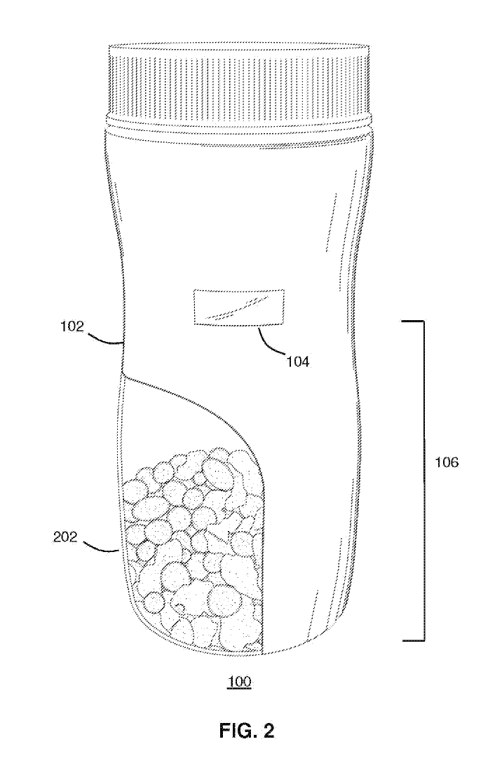

FIG. 1 depicts an exemplary yogurt smoothie kit 100. Kit 100 includes container 102, which has a demarcation in the form of transparent window 104. Transparent window 104 divides the volume of container 102 into a lower volume 106, below the bottom of window 104, and an upper volume 108, above the bottom of window 104. Kit 100 further includes a removable lid 110. FIG. 2 also depicts kit 100, with a cut-out showing consumable contents 202, an intermix of frozen yogurt pellets and frozen fruit pieces. Contents 202 occupies a portion of lower volume 106, though the contents are loosely packed prior to addition of fluid. To make a finished yogurt smoothie, a mixing liquid (e.g., orange juice) added until the liquid can be seen through window 104. At that point, the volume of mixing liquid is approximately equal to the volume of lower volume 106, minus the volume displaced by contents 202.

### Compositions, Methods, and Articles of Manufacture to Prepare Frozen Pellets

The present disclosure also provides articles of manufacture, methods, and compositions for preparing the frozen pellets of the present disclosure. Generally, prior to freezing, the frozen pellets are a liquid dispersion of dry ingredients in wet ingredients. Accordingly, compositions of the present invention may be mixtures of dry ingredients useful in preparing the frozen pellets, mixtures of wet ingredients useful for the same, or liquid mixtures (dispersions) of dry and wet ingredients. For example, a composition of the present disclosure may include a milk fluid at about 25% to about 78% by weight and a cream fluid at about 12% to about 55%, provided that the combined amount of the milk fluid and cream fluid ranges from about 62% to 90% by weight. The composition may further include a sweetener from about 10% to about 25% by weight, and/or a stabilizer mix at about 0.15% to about 2% by weight.

Another composition of the present disclosure may include a milk fluid at about 60% to about 80% by weight. A sweetener may be included, at about 10% to about 20% by weight, as well as a stabilizer mix at about 0.2% to about 0.6% by weight. Other optional ingredients in either composition include flavorings, buffers, fiber sources, emulsifiers, fats, oil, stabilizers, proteins, colorants, and nutritive additives.

As one of skill in the art will recognize, other compositions useful in the present invention may be mixtures of ingredients that, upon mixing with an appropriate fluid (e.g., a milk fluid), yield a liquid mixture for preparing the first or second frozen pellets. For example, a composition of the present invention can contain a mixture of a sweetener and a stabilizer mix. Such a composition is referred to herein as a sweetener component. Flavorings may optionally be included in the sweetener component, as well as other optional ingredients, as discussed previously. In certain embodiments, the sweetener component may be a dry mixture, while in other embodiments the sweetener component may be a paste, a gel, or a liquid.

The relative amounts of the ingredients in the sweetener component can vary depending on the amount of other ingredients (e.g., fluid components such as milk fluids) to be added when preparing the first or second frozen pellets. The fluid component for mixing with the sweetener component may include a milk fluid, and may further include a cream fluid and/or a flavoring.

Frozen pellets can be formed from the mixture of the sweetener component and the fluid component using the methods described above. The frozen pellets may then be packaged in a container.

Any of the compositions of the present disclosure may be provided as an article of manufacture. For example, the compositions, including a sweetener component, may be packaged in appropriate containers (e.g., drums, pouches, tubs, totes, bags, buckets, cartons) for easy transport to points of sale and preparation and for easy pouring and/or mixing. The article of manufacture may contain optional objects, such as utensils; containers for mixing; or other optional ingredients.

The articles of manufacture can include instructions for preparing frozen pellets. Such instructions can indicate that frozen pellets can be prepared by mixing the sweetener component with a fluid component and forming frozen pellets from the mixture. For example, the instructions can indicate that the sweetener component, or some portion thereof, can be mixed with appropriate amounts of one or more liquids, e.g., cream and milk, heated to disperse the dry ingredients, cooled, and flavorings and/or sweeteners added, if necessary, and in appropriate amounts. In general, depending on the type of pellet to be prepared, the instructions can direct the preparation of a liquid mixture having the appropriate ranges by weight, as discussed previously, of a milk fluid and/or cream fluid, sweetener, stabilizer mix, and/or flavorings. For example, an article of manufacture, useful for the preparation of first frozen pellets, can include instructions indicating that one can mix a sweetener component with a total amount of liquid to yield a mixture having a milk fluid at about 25% to about 78% by weight, a sweetener at about 10% to about 25% by weight, and a stabilizer mix at about 0.15% to about 2% by weight. In addition, the instructions can indicate that the liquid mixture may include a combined amount of milk fluid and cream fluid of about 62% to about 90% by weight. Appropriate instructions can be included to result in a liquid mixture suitable for preparation of second frozen pellets, e.g., a liquid containing about 60% to about 85% by weight of a milk fluid, about 10% to about 20% by weight of a sweetener, and about 0.2% to about 0.6% by weight of a stabilizer mix.

The instructions can further provide instructions related to one or more methods for forming the frozen pellets of the present invention, as described previously. Thus, instructions can indicate that the liquid mixtures may be frozen as slabs and cut into the appropriate shape, or frozen in molds of the appropriate shape and size. Other methods include those described in U.S. Pat. Nos. 5,126,156; 5,664,422; and 6,000,229, or the use of a Frigoscandia®. freezer, as described previously. Finally, the instructions may indicate that the frozen pellets can be packaged in a container.

The present disclosure will be further described in the following examples, which do not limit the scope of the invention described in the claims.

### EXAMPLES

### Example 1

### Preparation of First and Second Frozen Pellets

First frozen pellets

| | | |
|---|---|---|
| Ingredients: | Weight: | Percent by weight: |

| | | | |
|---|---|---|---|
| Whole milk | 240.00 | g | 54.258 |
| Trehalose | 60.00 | g | 13.565 |
| Heavy cream (40%) | 140.00 | g | 31.651 |
| Carageenan | 1.07 | g | 0.242 |
| Vanilla, pure | 1.00 | g | 0.226 |
| Ethyl Vanillin | 0.10 | g | 0.023 |
| Sucralose | 0.16 | g | 0.036 |

Procedure: The dry ingredients were weighed and then blended to disperse. The milk and cream were weighed together. Sucralose and flavorings were added to the milk and cream. While whisking the milk and cream mixture, the dry ingredients were added and the mixture was heated to 190° F. to solubilize the ingredients. The mixture was removed from the heat, and cooled in an ice bath to 40° F. The contents were poured into a shallow pan in a layer 0.25 in. thick and frozen quickly in dry ice. The mixture was allowed to temper overnight in freezer (0° F.). The pan was removed from the freezer, and the frozen mixture cut into pellets in the shape of cubes approximately 0.25 in. on a side. Pellets were held at 0° F. and then packaged.

In other embodiments, the flavorings and/or sweetener (e.g., sucralose) were added after cooling to 40° F. In yet other embodiments, the mixture is pasteurized (e.g., in a method complying with FDA requirements) prior to freezing.

Nutritional analysis: Genesis Version 7.01, published by ESHA Research of Salem Oreg. (Copyright 2001) was used to estimate the nutritional content of the first frozen pellets, including percent daily value based on a 2000 calorie diet. Based on this estimate, a 125 g serving of the first frozen pellets will have the following: calories: 190; calories from fat: 80; total fat: 9 g (14% DV); saturated fat: 6 g (30% DV); cholesterol: 40 mg (13% DV); sodium: 60 mg (3% DV); total carbohydrate: 23 g (8% DV); dietary fiber: 0 g; sugars: 22 g; protein 4 g; vitamin A: 6%; calcium: 10%; iron: 0%; vitamin C: 2%.

Second frozen pellets

| | | |
|---|---|---|
| Ingredients: | Weight: | Percent by weight: |

| | | | |
|---|---|---|---|
| Whole milk | 332.00 | g | 83.177 |
| Trehalose | 48.00 | g | 12.026 |
| Corn Syrup | 16.00 | g | 4.009 |
| Gelatin | 1.90 | g | 0.476 |
| Vanilla, pure | 1.00 | g | 0.251 |
| Ethyl Vanillin | 0.090 | g | 0.023 |
| Sucralose | 0.16 | g | 0.040 |

Procedure: The dry ingredients were weighed and then blended to disperse. The milk and corn syrup were weighed together. Sucralose and flavorings were added to the milk and cream. While whisking the milk and corn syrup mixture, the dry ingredients were added and the mixture was heated to 140° F. to solubilize the ingredients and held for 5 minutes. The mixture was removed from the heat, and cooled in an ice bath to 40° F. The contents were poured into a shallow pan in a layer 0.25 in. thick and frozen quickly in dry ice. The mixture was allowed to temper overnight in freezer (0° F.). The pan was removed from the freezer, and the frozen mixture cut into pellets in the shape of cubes approximately 0.25 in. on a side. Pellets were held at 0° F. and then packaged.

In other embodiments, the flavorings and/or sweetener (e.g., sucralose) were added after cooling to 40° F. In yet other embodiments, the mixture is pasteurized (e.g., in a method complying with FDA requirements) prior to freezing.

### Example 2

### Formulations of First Frozen Pellets

The following tables set forth various formulations prepared for the first frozen pellets of the present disclosure. Formulas 1-8 are useful for the preparation of first frozen pellets in methods and articles employing two sets of frozen pellets, while formulas 9-16 are useful in methods and articles employing one set of frozen pellets. Note that the “stabilizer” used in formulas 5-13 is a commercial blend of microcrystalline cellulose and sodium carboxymethylcellulose called Gelstar GC200 (FMC Corporation, Philadelphia, Pa.).

| | | |
|---|---|---|
| Ingredients: | Weight: | Percent by weight: |

Formula 1:

| | | | |
|---|---|---|---|
| Whole milk | 240.00 | g | 54.258 |
| Trehalose | 60.00 | g | 13.565 |
| Heavy cream (40%) | 140.00 | g | 31.651 |
| Carageenan | 1.07 | g | 0.242 |
| Vanilla, pure | 1.00 | g | 0.226 |
| Ethyl Vanillin | 0.10 | g | 0.023 |
| Sucralose | 0.16 | g | 0.036 |

Formula 2:

| | | | |
|---|---|---|---|
| Whole milk | 240.00 | g | 54.014 |
| Trehalose | 60.00 | g | 13.503 |
| Heavy cream (40%) | 140.00 | g | 31.508 |
| Carageenan | 1.07 | g | 0.241 |
| Gelatin | 2.00 | g | 0.450 |
| Vanilla, pure | 1.00 | g | 0.225 |
| Ethyl Vanillin | 0.10 | g | 0.023 |
| Sucralose | 0.16 | g | 0.036 |

Formula 3:

| | | | |
|---|---|---|---|
| Whole milk | 140.00 | g | 31.362 |
| Trehalose | 60.00 | g | 13.441 |
| Heavy cream (40%) | 240.00 | g | 53.763 |
| Carageenan | 3.14 | g | 0.703 |
| Gelatin | 2.00 | g | 0.448 |
| Vanilla, pure | 1.00 | g | 0.224 |
| Ethyl Vanillin | 0.10 | g | 0.022 |
| Sucralose | 0.16 | g | 0.036 |

Formula 4:

| | | | |
|---|---|---|---|
| Whole milk | 140.00 | g | 31.226 |
| Trehalose | 60.00 | g | 13.383 |
| Heavy cream (40%) | 240.00 | g | 53.531 |
| Carageenan | 3.14 | g | 0.700 |
| Gelatin | 2.00 | g | 0.446 |
| Vanilla, pure | 3.00 | g | 0.0.669 |
| Sucralose | 0.20 | g | 0.045 |

Formula 5:

| | | | |
|---|---|---|---|
| Whole milk | 140.00 | g | 30.804 |
| Trehalose | 60.00 | g | 13.202 |
| Heavy cream (40%) | 240.00 | g | 52.806 |
| Carageenan | 1.57 | g | 0.345 |
| Stabilizer | 2.60 | g | 0.572 |
| Gelatin | 2.00 | g | 0.440 |
| Vanilla, pure | 8.00 | g | 1.760 |
| Sucralose | 0.32 | g | 0.070 |

Formula 6:

| | | | |
|---|---|---|---|
| Whole milk | 240.00 | g | 53.294 |
| Trehalose | 60.00 | g | 13.324 |
| Heavy cream (40%) | 140.00 | g | 31.088 |
| Carageenan | 1.57 | g | 0.349 |
| Stabilizer | 2.60 | g | 0.577 |
| Gelatin | 2.00 | g | 0.444 |
| Vanilla, pure | 4.00 | g | 0.888 |
| Sucralose | 0.16 | g | 0.036 |

Formula 7:

| | | | |
|---|---|---|---|
| Whole milk | 240.00 | g | 45.388 |
| Maltodextrin | 80.00 | g | 15.129 |
| Trehalose | 60.00 | g | 11.347 |
| Heavy cream (40%) | 140.00 | g | 26.477 |
| Carageenan | 1.57 | g | 0.297 |
| Stabilizer | 2.60 | g | 0.492 |
| Lecithin | 0.60 | g | 0.113 |
| Vanilla, pure | 4.00 | g | 0.756 |

Formula 8:

| | | | |
|---|---|---|---|
| Whole milk | 240.00 | g | 45.388 |
| Maltodextrin | 80.00 | g | 15.129 |
| Sugar solids (sucrose) | 60.00 | g | 11.347 |
| Heavy cream (40%) | 140.00 | g | 26.477 |
| Carageenan | 1.57 | g | 0.297 |
| Stabilizer | 2.60 | g | 0.492 |
| Lecithin | 0.60 | g | 0.113 |
| Vanilla, pure | 4.00 | g | 0.756 |

Formula 9:

| | | | |
|---|---|---|---|
| Whole milk | 240.00 | g | 45.453 |
| Maltodextrin | 80.00 | g | 15.151 |
| Sugar solids (sucrose) | 60.00 | g | 11.363 |
| Heavy cream (40%) | 140.00 | g | 26.514 |
| Carageenan | 0.57 | g | 0.108 |
| Stabilizer | 2.60 | g | 0.492 |
| Lecithin | 0.60 | g | 0.114 |
| Vanilla, pure | 4.00 | g | 0.756 |
| Sucralose | 0.25 | g | 0.047 |

Formula 10:

| | | | |
|---|---|---|---|
| Whole milk | 240.00 | g | 45.337 |
| Maltodextrin | 80.00 | g | 15.112 |
| Sugar solids (sucrose) | 60.00 | g | 11.334 |
| Heavy cream (40%) | 140.00 | g | 26.447 |
| Carageenan | 1.57 | g | 0.297 |
| Stabilizer | 2.60 | g | 0.491 |
| Lecithin | 0.60 | g | 0.113 |
| Vanilla, pure | 4.00 | g | 0.756 |
| Sucralose | 0.60 | g | 0.113 |

Formula 11:

| | | | |
|---|---|---|---|
| Whole milk | 240.00 | g | 41.829 |
| Maltodextrin | 80.00 | g | 13.943 |
| Sugar solids (sucrose) | 60.00 | g | 10.457 |
| Heavy cream (40%) | 180.00 | g | 31.371 |
| Carageenan | 1.57 | g | 0.274 |
| Stabilizer | 2.60 | g | 0.453 |
| Lecithin | 0.60 | g | 0.105 |
| Vanilla, pure | 3.00 | g | 0.523 |
| Soy Whipping Agent | 6.00 | g | 1.046 |

Formula 12:

| | | | |
|---|---|---|---|
| Whole milk | 240.00 | g | 41.611 |
| Maltodextrin | 80.00 | g | 13.870 |
| Sugar solids (sucrose) | 60.00 | g | 10.403 |
| Heavy cream (40%) | 140.00 | g | 24.273 |
| Carageenan | 0.57 | g | 0.099 |
| Stabilizer | 2.60 | g | 0.451 |
| Lecithin | 0.60 | g | 0.105 |
| Vanilla, pure | 3.00 | g | 0.520 |
| Soybean oil | 50.00 | g | 8.669 |

Formula 13:

| | | | |
|---|---|---|---|
| Whole milk | 240.00 | g | 41.253 |
| Maltodextrin | 80.00 | g | 13.751 |
| Sugar solids (sucrose) | 160.00 | g | 10.313 |
| Heavy cream (40%) | 140.00 | g | 24.064 |
| Carageenan | 0.57 | g | 0.098 |
| Stabilizer | 2.60 | g | 0.447 |
| Lecithin | 0.60 | g | 0.103 |
| Vanilla, pure | 2.00 | g | 0.344 |
| Soybean oil | 50.00 | g | 8.594 |
| Soy Whipping Agent | 6.00 | g | 1.031 |

Formula 14:

| | | | |
|---|---|---|---|
| Whole milk | 240.00 | g | 43.68 |
| Corn Syrup | 60.00 | g | 10.92 |
| Sugar solids (sucrose) | 60.00 | g | 10.92 |
| Heavy cream (40%) | 140.00 | g | 25.48 |
| Carageenan | 1.50 | g | 0.27 |
| Lecithin | 0.50 | g | 0.09 |
| Vanilla, pure | 2.00 | g | 0.36 |
| Soybean oil | 40.00 | g | 7.28 |
| Soy Whipping Agent | 5.50 | g | 1.00 |

Formula 15:

| | | | |
|---|---|---|---|
| Whole milk | 281 | g | 70.299 |
| Sugar solids (sucrose) | 20 | g | 5.00 |
| Corn Syrup | 4 | g | 1.00 |
| 65% High Maltose Syrup | 8 | g | 2.00 |
| Cream | 62.4 | g | 15.60 |
| Flvr Vanillin | 1.04 | g | 0.26 |
| Ethyl Vanillin | 0.08 | g | 0.02 |
| Stabilizer, Daritech FR 102 | 1.2 | g | 0.30 |
| Inulin | 14 | g | 3.50 |
| Maltodextrin 10DE | 8 | g | 2.00 |
| Sucralose | 0.072 | g | 0.018 |

Procedure: The dry ingredients were weighed and then blended to disperse. The milk and corn syrup were weighed together. Sucralose and flavorings were added to the milk and cream. While whisking the milk and corn syrup mixture, the dry ingredients were added and the mixture was heated to 140° F. to solubilize the ingredients and held for 5 minutes. The mixture was then homogenized at 500 and 2500 PSI and then pasteurized using a pilot scale thermal process. The mix was then cooled to around 10° C. and then allowed to age for between 4 and 24 hours. A pilot scale 20 liter liquid Dewar was filled with liquid nitrogen to create a bath and drops were created by pouring the pellet mix liquid through a strainer. This created frozen pellets of small diameter which were spherical.

In other embodiments, the flavorings and/or sweetener (e.g., sucralose) were added after cooling to 40° F. In yet other embodiments, the mixture is pasteurized (e.g., in a method complying with FDA requirements) prior to freezing.

Formula 16:

| | | |
|---|---|---|
| Ingredients: | Weight: | Percent by weight: |

| | | | |
|---|---|---|---|
| Whole milk | 281 | g | 70.257 |
| Sugar solids (sucrose) | 40 | g | 10.00 |
| Corn Syrup | 4 | g | 1.00 |
| 65% High Maltose Syrup | 12 | g | 3.00 |
| Cream | 60.6 | g | 15.160 |
| Flvr Vanillin | 1.04 | g | 0.26 |
| Ethyl Vanillin | 0.08 | g | 0.02 |
| Stabilizer, Daritech FR 102 | 1.2 | g | 0.30 |
| Sucralose | 0.04 | g | 0.010 |

Procedure: The dry ingredients were weighed and then blended to disperse. The milk and corn syrup were weighed together. Sucralose and flavorings were added to the milk and cream. While whisking the milk and corn syrup mixture, the dry ingredients were added and the mixture was heated to 140° F. to solubilize the ingredients and held for 5 minutes. The mixture was then homogenized at 500 and 2500 PSI and then pasteurized using a pilot scale thermal process. The mix was then cooled to around 10° C. and then allowed to age for between 4 and 24 hours. A pilot scale 20 liter liquid Dewar was filled with liquid nitrogen to create a bath and a drops were created by pouring the pellet mix liquid through a strainer. This created frozen pellets of small diameter which were spherical.

### Example 3

### Formulations of Second Frozen Pellets

The following tables set forth various formulations prepared for the second frozen pellets of the present disclosure.

| | | |
|---|---|---|
| Ingredients: | Weight: | Percent by weight: |

Formula 1:

| | | | |
|---|---|---|---|
| Whole milk | 332.00 | g | 83.177 |
| Trehalose | 48.00 | g | 12.026 |
| Corn Syrup | 16.00 | g | 4.009 |
| Gelatin | 1.90 | g | 0.476 |
| Vanilla, pure | 1.00 | g | 0.251 |
| Ethyl Vanillin | 0.090 | g | 0.023 |
| Sucralose | 0.16 | g | 0.040 |

Formula 2:

| | | | |
|---|---|---|---|
| Whole milk | 332.00 | g | 82.772 |
| Trehalose | 48.00 | g | 11.967 |
| Corn Syrup | 16.00 | g | 3.989 |
| Gelatin | 1.90 | g | 0.474 |
| Vanilla, pure | 3.00 | g | 0.748 |
| Sucralose | 0.20 | g | 0.050 |

Formula 3:

| | | | |
|---|---|---|---|
| Whole milk | 332.00 | g | 81.756 |
| Trehalose | 48.00 | g | 11.820 |
| Corn Syrup | 16.00 | g | 3.940 |
| Gelatin | 1.90 | g | 0.468 |
| Vanilla, pure | 8.00 | g | 1.970 |
| Sucralose | 0.160 | g | 0.039 |
| Yellow #5 | 0.025 | g | 0.006 |

Formula 4:

| | | | |
|---|---|---|---|
| Whole milk | 332.00 | g | 83.438 |
| Trehalose | 48.00 | g | 12.063 |
| Corn Syrup | 16.00 | g | 4.021 |
| Gelatin | 1.90 | g | 0.478 |

Formula 5:

| | | | |
|---|---|---|---|
| Whole milk | 332.00 | g | 83.438 |
| Sugar solids (sucrose) | 48.00 | g | 12.063 |
| Corn Syrup | 16.00 | g | 4.021 |
| Gelatin | 1.90 | g | 0.478 |

### Example 4

### Preparation of a Frozen Beverage

A number of frozen beverages were prepared according to the methods and compositions of the present invention. For methods employing first frozen pellets, first frozen pellets prepared with formulations 9-14, set out above, were used. 100 g of the first frozen pellets in a shaker cup were manually shaken vigorously with 100 g of the liquid for 30 sec. Generally, the liquid for mixing was whole milk. Frozen beverages of a desirable consistency, flavor, and mouth feel were obtained.

For methods employing first and second frozen pellets, first frozen pellets corresponding to formulations 1-8 and second frozen pellets corresponding to formulations 1-5 were prepared. To prepare a frozen beverage, first frozen pellets and second frozen pellets were placed in a shaker cup in a ratio of 40:60, respectively, or 50 grams first frozen pellets and 75 grams second frozen pellets. Depending on desired consistency of the end product, 100 to 150 grams of whole milk were added to the 125 g of total frozen pellets in the container. The mixture was shaken vigorously for about 30 seconds, and frozen beverages of a desirable consistency, flavor, and mouth feel were obtained.

Nutritional analysis: Genesis Version 7.01, published by ESHA Research of Salem Oreg. (Copyright 2001) was used to estimate the nutritional content of a frozen beverage prepared as above using first frozen pellets having first frozen pellet formulation 1, and second frozen pellets having second frozen pellet formulation 1, with whole milk as the liquid for mixing. The nutritional data includes percent daily value based on a 2000 calorie diet. Based on this estimate, a 250 g serving of the frozen beverage will have the following: calories: 270; calories from fat: 120; total fat: 13 g (21% DV); saturated fat: 9 g (43% DV); cholesterol: 55 mg (19% DV); sodium: 120 mg (5% DV); total carbohydrate: 29 g (10% DV); dietary fiber: 0 g; sugars: 27 g; protein 8 g; vitamin A: 10%; calcium: 25%; iron: 0%; vitamin C: 4%.

### Example 5

### Viscosity Testing of Frozen Beverages

Frozen beverages of the present invention were characterized by viscometry measurements. Flow distance of a frozen beverage over a set time period was measured in a consistometer device (Bostwick Consistometer, CSC Scientific Co., Fairfax, Va.). Results were compared to a “gold standard” frozen beverage (e.g., a traditional milk shake made at home with ice cream and milk in a blender, or a milk shake purchased from a fast food outlet). A typical homemade milk shake was prepared with equal parts of ice cream (e.g., Haagen-Dazs®) to whole milk and blended in a household blender for about 15 to 20 sec.

Two frozen beverages and one traditional milk shake were prepared and immediately tested by pouring a sample of each into a Bostwick consistometer chamber. The flow distance of the icy slush portion of each was read after 15 seconds of flow. The remaining portions of the frozen beverage and the traditional milk shake were allowed to sit for 5 minutes and the measurements were repeated. The results were as follows:

Sample #1

Frozen Beverage Reading at time 0: <0.5 cm/15 seconds Frozen Beverage Reading at 5 minutes: 10 cm/15 seconds

Sample #2

Frozen Beverage Reading at time 0: 0.5 cm/15 seconds Frozen Beverage Reading at 5 minutes: 12 cm/15 seconds Traditional Milkshake (home-made) Reading at time 0: 20 cm/15 seconds Reading at 5 minutes: >23 cm/15 seconds

In general, these results show that the frozen beverages prepared according to the method of the present invention are slushier and thus thicker products than a home-made milk shake.

### Example 6

### Analysis of Physical Properties of Pellets

Experimental methods were developed to determine melting rate, hardness, and melting temperatures of first pellets. First pellets having two different sweetener profiles were prepared. The effect of overrun was also examined. In addition, the effects of three different coatings were investigated to understand whether coating affects the appearance and flowability

The viscosity of pellet mixes and the coating solutions were analyzed. Frozen pellets were analyzed for hardness, melting rate, and melting profile during a 4 week storage in a freezer. Furthermore, the effect of tempering on pellet melting properties and hardness was investigated. The main findings of this study are given below:

1. A combination of sugar and inulin as a sweetener resulted in a slower melting rate as compared to sugar or inulin alone. Thus, inulin was found to improve the melting behavior of the pellets.

2. Neither the composition of the pellets nor the tempering profile altered or improved the melting properties significantly.

3. Polysorbate 80, added as an emulsifier, caused an increase in the melting rate, which may not be desirable in certain circumstances.

4. With the exception of starch-coated pellets, there were no significant differences in melting rate and melting temperature between coated and uncoated pellets.

5. Coated pellets, however, had a significantly better appearance and flowability as compared to uncoated pellets.

This study was conducted in two phases. During the first phase, two different pellet compositions were analyzed for hardness, melting rate, viscosity, and melting onset temperature. One of the pellet compositions was whipped to result in overrun, and similarly analyzed. The second phase was to examine the effect of three coating materials on viscosity, melting rate, and melting onset temperature of the pellets.

Phase I Compositions and Analysis

In the first phase, two pellet formulations were designed to have two different sweetener profiles, and one was whipped to evaluate the effects of composition and whipping on melting properties and hardness of the pellets. The sweetener profiles are given below:

Pellet I—sugar formulation

Pellet II—inulin formulation

Pellet III—sugar formulation, but whipped to result in overrun

Table 1 shows the formulations. Note that Pellet I formulation was whipped at chilled temperature to result in overrun (Pellet III).

TABLE 1
Composition of Pellet Mixes I, II and III

| | |
|---|---|
| Ingredient | % Weight (w/w) |

Pellets I and III

| | |
|---|---|
| Sweetener 25% Sucralose | 0.04 |
| Sugar (JCSC) | 10.00 |
| Corn Syrup Solids (42 DE) dry basis | 1.00 |
| Satin Sweet 65% High Maltose Corn Syrup | 3.00 |
| Milk (ICSC) | 70.227 |
| Cream (ICSC) | 15.163 |
| Flavor, Vanilla 4X (Nielsen-Massey) | 0.25 |
| Ethyl Vanillin | 0.02 |
| Stabilizer, Daritech FR 102, Degussa | 0.30 |

Pellet II

| | |
|---|---|
| Sweetener 25% Sucralose | 0.10 |
| Corn Syrup Solids (42 DE) dry basis | 1.00 |
| Satin Sweet 65% High Maltose Corn Syrup | 4.00 |
| Milk (ICSC) | 70.227 |
| Cream (ICSC) | 15.603 |
| Flavor, Vanilla 4X (Nielsen-Massey) | 0.25 |
| Ethyl Vanillin | 0.02 |
| Stabilizer, Daritech FR 102, Degussa | 0.30 |
| Inulin, Instant, Oliggo-Fiber | 3.50 |
| Maltodextrin (10DE) | 5.00 |

The pellet mixes were heated to 185° F. for two minutes and homogenized at 500 and 3000 PSI with a two-stage homogenizer. The mixes were aged overnight and the viscosity was measured. Pellet III formulation was whipped at chilled temperature and overrun was compared to the unwhipped formulation (Pellet I).

Both pellets and pucks were prepared by freezing the mixes using liquid nitrogen:

Pellets were prepared by dripping the mix thorough a strainer into a liquid nitrogen bath to obtain round pellets;

Pucks were prepared by filling the mix into a plastic container in the amount of 42+/−2 gram, then dipping the container in liquid nitrogen.

After whipping, the Pellet III mix had an overrun value of 101.4%. However, this overrun could not be maintained during production of frozen pellets and pucks due to the collapsing of air cells; they appeared to shudder upon contact with liquid nitrogen.

Pellets and pucks were placed into two different freezer temperatures: a domestic freezer (−10° F. (−23.3° C.)) and a commercial freezer (−26° F. (−32.2° C.), for a week. After completion of one-week storage, the samples (pellets and pucks) were transferred to the domestic freezer. Effects of tempering were evaluated by measuring melting rate and melting temperatures after 2 and 4 weeks of production.

### Melting Rate

Two different sets of frozen samples, pucks and pellets, of a pellet mix were analyzed to calculate the melting rate.

### Puck-Shape Samples

The pellet mix was filled into sample cups to make a puck-shape sample that weighed 42+/−2 grams. The sample was frozen in liquid nitrogen. The frozen puck sample was placed on a wire screen (10 holes/cm) on a top of a funnel that was attached to a graduated cylinder. Every 5 minutes, the dripped volume was recorded for up to 40 minutes. The temperature of the room was kept constant at 22° C. The time in minutes was plotted against the dripped volume (ml) and slope of the main melting event was taken as the melting rate.

### Pellets

10 grams of pellets were placed on a wire screen (10 holes/cm) on a top of a funnel that was attached to a graduated cylinder. The dripped volume was recorded every 2 minutes up to 10 minutes. The temperature of the room was kept constant at 22° C. The time in minutes was plotted against the dripped volume (ml) and slope to the main melting event was taken as the melting rate.

### Melting Profile

A Mettler DSC was used to determine melting profiles of the pellets. Samples were kept in a Styrofoam box with dry ice to prevent melting of the samples before loading the DSC. DSC sampling pans were also kept in the dry ice. Pellet samples of 10-15 mg were placed into a sampler holder. The DSC sample loading temperature was adjusted to −15° C. to prevent melting during loading and at the beginning of a heating scan. The temperature profile was held at −15° C. for a minute, then further cooling to −30° C. at a rate of 5° C./min and heating from −30° C. to 40° C. at a rate of 5° C./min. The onset temperature of the melting peak was chosen as a melting temperature.

### Hardness

A texture analyzer (TA-Hdi, Stable Micro Systems) was used to measure the hardness of pucks stored at both commercial and domestic freezer temperatures. Samples were kept in dry ice until analysis. The surface of the measurement stand and the probe were cooled by placing dry ice on their surfaces. Samples were quickly transported to the texture analyzer, and the analyses were completed within 30 s to minimize variability due to sample warming. A 42 g stainless steel probe (TA-42 (45.degree. Chisel), Stable Micro Systems) was used to measure the force required for 7 mm penetration into the samples, with force directly proportional to the hardness. Three measurements were taken per sample.

### Mix Viscosity

A rheometer (Paar Physica) was used to measure the viscosity of freshly prepared pellet mixes at 25° C. and at 5° C. after 24 hours of aging in a refrigerator as a function of shear rate from high to low (200 to 0.1 s.sup.-1) and from low to high (0.1 to 200 s.sup.-1). In addition, flow behaviors of the pellet mixes were determined.

### Results and Discussion

The viscosities of the mixes at 25° C. were not significantly different as a function of shear rate. As expected, after aging overnight at refrigeration temperature, the viscosity of the mixes increased due to the decrease in temperature. However, no significant difference in viscosity was observed between Pellet I and II formulations at 5° C. The viscosity of the mixes decreased as the shear rate decreased. Thus, the mixes had shear thinning behavior, which should be considered during production.

With respect to melting rates, the Pellet I pellets had the fastest melting rate, followed by the Pellet III whipped pellets, whereas the Pellet II pellets had the slowest melting rate. The trend did not change after 4 weeks of storage. Additionally, the results suggest that freezer temperatures and tempering of pellets between two different temperatures did not significantly change the melting rates of the pellets. The pucks made with inulin had the slowest melting rate, whereas Pellet I and III pucks had the fastest melting rate. These results suggest that the size of the frozen piece, either in pellet shape or puck shape, may not affect the melting rate. The composition of the formulation, e.g., sugar versus inulin, seemed to be the most important parameter affecting the melting rate.

In general, the hardness of the Pellet I and II pucks did not significantly change over the course of the storage. At zero time, Pellet I pucks were the hardest, whereas Pellet II pucks were the softest. The Pellet III pucks made had intermediate hardness. After storage in two different freezer temperatures for a week, their hardness profiles changed. The Pellet III pucks were the softest, followed by the Pellet I pucks. The Pellet II pucks were the hardest.

Additionally, the temperature of the freezer was found to affect the hardness. Pucks held at −26° F. were harder than ones held at −10° F. After 1 week, the pucks were stored at −10° F. for an additional week. The hardness analysis showed that the samples first stored at −26° F. and then at −10° F. got slightly softer, while the samples held at −10° F. the entire time got harder. It should be noted, however, that the surfaces of the pucks were not flat due to difficulties in making flat surface pucks in liquid nitrogen and thus the comparison of hardness may be misleading. Therefore, the hardness measurements were not performed after the two-week storage.

Melting onset temperatures were determined from the melting curves obtained from DSC analysis. Table 2 tabulates the melting onset temperatures of the pellets as a function of storage time. At t=0, immediately after production of the pellets, the melting onset temperatures of the Pellets III, I, and II were −3.4° C., −4.2° C., and −2.7° C., respectively. After one week storage at two different freezer temperatures, all pellets were transferred into the domestic freezer. At the end of the four week storage, pellets I and III had lower melting onset temperatures than pellets II. This result confirms the conclusion that the addition of inulin was successful in increasing the melting onset temperature, which may be important to give increased stability to the pellets during the freeze-thaw cycles that occur during distribution and storage.

TABLE 2
DSC Melting Onset Temperature

| | Pellet I | Pellet I | Pellet II | Pellet II | Pellet III | Pellet III |
|---|---|---|---|---|---|---|
| Time | Domestic | Commercial | Domestic | Commercial | Domestic | Commercial |
| (weeks) | Freezer | Freezer | Freezer | Freezer | Freezer | Freezer |
| 0 | −4.2 | −4.2 | −2.7 | −2.7 | −3.4 | −3.4 |
| 1 | −1.0 | −3.7 | 0.5 | −1.1 | −1.1 | −2.8 |
| 2 | −2.2 | 0.2 | −3.1 | −3.4 | −5.0 | −4.5 |
| 4 | −3.6 | −4.9 | −0.5 | −2.9 | −3.6 | −5.1 |

### Phase II—Effects of Coatings on Pellet Behavior

Based on the results of Phase I, a new formulation was prepared that included a mixture of sugar and inulin, Pellet IV. In addition, another formulation, Pellet V, was prepared to determine effects of a stabilizer, Polysorbate 80, on the melting properties of the pellets. The formulations of Pellets IV and V are given in Table 3.

TABLE 3
Formulations of Pellets IV and V

| | |
|---|---|
| Ingredients | % Weight (w/w) |

Pellet IV

| | |
|---|---|
| Sweetener 25% Sucralose | 0.070 |
| Corn Syrup Solids (42 DE) dry basis | 1.000 |
| Satin Sweet 65% High Maltose Corn Syrup | 2.000 |
| Milk (ICSC) | 70.257 |
| Cream (ICSC) | 15.603 |
| Flavor, Vanilla 4X (Nielsen-Massey) | 0.250 |
| Ethyl Vanillin | 0.020 |
| Stabilizer, Daritech FR 102, Degussa | 0.300 |
| Inulin, Instant, Oliggo-Fiber | 3.500 |
| Maltodextrin (10DE) | 2.000 |
| Sugar (ICSC) | 5.000 |

Pellet V

| | |
|---|---|
| Sweetener 25% Sucralose | 0.070 |
| Corn Syrup Solids (42 DE) dry basis | 1.000 |
| Satin Sweet 65% High Maltose Corn Syrup | 2.000 |
| Milk (ICSC) | 70.157 |
| Cream (ICSC) | 15.603 |
| Flavor, Vanilla 4X (Nielsen-Massey) | 0.250 |
| Ethyl Vanillin | 0.020 |
| Stabilizer, Daritech FR 102, Degussa | 0.300 |
| Inulin, Instant, Oliggo-Fiber | 3.500 |
| Maltodextrin (10DE) | 2.000 |
| Sugar (ICSC) | 5.000 |
| Polysorbate 80 | 0.100 |

Pellets were prepared as described above. Melting rate and melting temperatures of the pellets were determined as described above. Pellets were kept in a commercial freezer (−26° F.) for a week, then transferred to a domestic freezer (−10° F.). The effects of coating materials on the melting properties and appearance of the pellets were also examined. Three different coating solutions were prepared:

Solution 1—4% cold swelling starch-Polar Tex 06748

Solution 2—2% defoamer SAG 100, 1% sodium citrate

Solution 3—10% Trehalose solution

The coating solutions were used to coat Pellet IV pellets. The pellets were coated by spraying the coating solution onto pellets, and liquid nitrogen was poured down over the pellets to keep them cold. The process was repeated several times until the formation of a visible and smooth coat on the surface of the pellets. The pellets were coated with Solution 1, 2 or 3 alone.

A Mettler DSC was used to investigate crystallization and melting behavior of the coating solutions. A coating solution was placed into a DSC sample pan in the amount of 6-12 milligrams. The sample pans were then transferred into the DSC at room temperature. The samples were cooled to −30° C. at a rate of 2° C./min to observe their crystallization behavior, and heated up to 15° C. at the same rate to observe melting behavior of the crystals. Table 4 shows the crystallization onset temperature and melting onset temperature of the coating solutions.

TABLE 4
Crystallization and Melting Behavior of Coating Solutions

| | Crystallization Onset | Melting Onset |
|---|---|---|
| Coating Solution | Temperature (° C.) | Temperature (° C.) |
| 4% cold swelling starch | −19.96 | 1.85 |
| 2% SAG + 1% Sodium | −19.47 | −1.36 |
| Citrate | | |
| 10% trehalose | −15.74 | −2.31 |

The results showed that crystallization onset temperatures of the 4% cold swelling starch and 2% SAG+1% Sodium Citrate solutions were very similar to each other, whereas their melting onset temperatures were significantly different from each other. This result implies that the solids used in these solutions may affect the structure of the ice crystals. The 10% trehalose solution had a higher crystallization temperature and lower melting onset temperature as compared to the others. Thus, the composition or amount of solid, or both, affected the crystallization and melting profile of the coating solutions.

Melting temperatures of the pellets were determined according to the method given in above. As mentioned previously, based on the results of the Phase I study, there was no significant effect of the freezer temperatures investigated in this study on the melting behavior of the pellets. In Phase II, we decided to mimic ice cream storage conditions. Thus, pellets and pucks were kept in a commercial freezer (−26° F. (−32.2° C.)) for a week, and then were transferred to a domestic freezer and held there for 4 weeks.

TABLE 5
Melting Onset Temperature of Pellets

| | | | Pellet | Pellet | Pellet |
|---|---|---|---|---|---|
| Time | Pellet | Pellet | IV + 10% | IV + 4% | IV SAG + |
| (Weeks) | IV | V | Trehalose | Starch | 1% SC |
| 1 | −3.9 | −4.1 | −3.2 | −3.8 | −0.6 |
| 2 | −3.6 | −0.4 | −0.8 | −3.2 | −3.6 |
| 4 | −4.3 | −4.2 | −3.8 | −2.2 | −3.3 |

After one week storage, the melting onset temperature of Pellet IV (uncoated) was around −4° C. Coating Pellet IV with trehalose and starch did not make a significant difference in the melting onset temperature, whereas coating with 2% SAG+1% Sodium Citrate increased the melting onset temperature to 0.6° C. After one week storage time in the commercial freezer at −26° F., all pellets were transferred in to a domestic freezer at −10° F. After two-week storage at domestic freezer temperatures, the melting onset temperatures of the pellets was variable, but eventually at the end of the fourth week, the melting onset temperatures of pellets IV settled at around −4.3° C. The trehalose-coated pellets had slightly higher melting onset temperatures than the uncoated ones, but the difference was not significant. The starch-coated pellets had better melting behavior than both the trehalose-coated and SAG+sodium citrate-coated pellets. Addition of the surfactant Polysorbate 80 (Pellet V) did not affect the melting onset temperature of Pellet IV after a four-week storage.

Except for the starch coating, the coating materials did not significantly affect the melting behavior of Pellet IV. However, the coated pellets had more flowability as compared to uncoated Pellets IV and V. After four-week storage, the uncoated pellets stuck to one another and it was difficult to remove them from the containers. Thus, coated pellets had better appearance and flowability than uncoated pellets. Coating pellets improved handling and storage quality which may be important during pellet storage.

Pellets IV and V demonstrated a difference in melting rate during the first two weeks; however, at the end of the fourth week, the melting rates were not significantly different. In general, the coated Pellet IV pellets had a faster melting rate as compared to uncoated Pellet IV pellets. The type of coating material did not significantly affect the melting rate. These results align with the findings of the DSC analysis in which we did not observe a significant effect of coating materials on the melting behavior of pellets.

### Conclusions—Effect of Coatings on Pellet Behavior

1. The melting and crystallization behavior of the coating materials showed some differences. Both starch and SAG+Sodium citrate solutions crystallized at around −20° C., whereas the trehalose solution crystallized at around −15° C. Melting temperatures of the crystals were found to be different from each other. These results suggested that either the composition or amount of solid, or both, affected the crystallization and melting profiles of the coating solutions.

2. Melting onset temperatures of the pellets were variable during a two-week storage; however, after a four-week-storage, they had a similar melting profile, with the exception of the starch-coated pellets. Polysorbate 80 seemed to increase the melting rate of the pellets.

3. Except for the starch coating, the coatings used herein did not significantly affect the melting behavior of the pellets.

4. Coated pellets had better appearance and flowability than uncoated pellets.

### Example 7

### Effect of Scale-Up on Pellet Properties

The objective of this study was to analyze melting properties of pellets produced at a pilot-plant scale in two 1400 lb batches. The melting properties of the pellets produced at lab- and pilot-scale were compared. Nutritional analyses and sensory evaluations were also performed. Formulations for Pellets VI and VII are shown below.

TABLE 6
Composition of Pellets VI and VII

| | |
|---|---|
| Ingredients | % Weight (w/w) |

Pellets VI

| | |
|---|---|
| Sucralose | 0.01 |
| Sugar (ICSC) | 10.00 |
| Corn Syrup Solids (42 DE) dry basis | 1.00 |
| Satin Sweet 65% High Maltose Corn Syrup | 3.00 |
| Milk (ICSC) | 70.257 |
| Cream (ICSC) | 15.163 |
| Flavor, Vanilla 4X (Nielsen-Massey) | 0.25 |
| Ethyl Vanillin | 0.02 |
| Stabilizer, Daritech FR 102, Degussa | 0.30 |

Pellets VII

| | |
|---|---|
| Sucralose | 0.0175 |
| Corn Syrup Solids (42 DE) dry basis | 1.00 |
| Satin Sweet 65% High Maltose Corn Syrup | 2.00 |
| Milk (ICSC) | 70.299 |
| Cream (ICSC) | 15.603 |
| Flavor, Vanilla 4X (Nielsen-Massey) | 0.26 |
| Ethyl Vanillin | 0.02 |
| Stabilizer, Daritech FR 102, Degussa | 0.30 |
| Inulin, Instant, Oliggo-Fiber | 3.50 |
| Maltodextrin (10DE) | 2.00 |
| Sugar (ICSC) | 5.00 |

The melting rates and melting temperatures of the pellets are shown in Table 7.

TABLE 7
Melting Rate and Melting Onset Temperature of Pellets VI and VII

| | Melting Rate | Melting Onset |
|---|---|---|
| Sample | (ml/min) | Temperature (° C.) |
| Pellets VI | 0.5 | −4.5 |
| Pellets VII | 0.1 | −2.2 |

The melting onset temperature of Pellets VI was −4.5° C., whereas the melting onset temperature of Pellets VII was −2.2° C. Thus, inulin-containing pellets start to melt at a higher temperature than the sucrose-containing pellets. In addition, Pellets VI made with sucrose had a faster melting rate than Pellets VII made with inulin. Pellets VI melted 5.times. faster than Pellets VII. The difference in melting onset temperatures indicates better temperature stability of Pellets VII as compared to Pellets VI, as Pellets VII would be less likely to melt during storage and distribution. In addition, Pellets VII maintained their shape during the experiment time, suggesting a possible strong binding between molecules.

Nutritional analysis of Pellets VI indicated 7.15% milkfat, 2.54% protein, and 28.6% solids. Nutritional analysis of Pellets VII indicated 7.87% milkfat, 2.65% protein, and 29% solids.

After two months of storage at −20° F., Pellets VI and VII were made into a milkshake, as described previously. Pellets VI produced a frozen beverage that had vanilla flavor, but was a little watery, had an icy texture, and lacked some dairy notes. Pellets VII produced a frozen beverage that had a creamy mouth-feel with much better flavor retention. A Brookfield viscometer confirmed that the pellets containing inulin (Pellets VII) had increased viscosity.

Overall, inulin improved the melting behavior of the pellets, their shape retention, and their sensory qualities. In addition, the findings of the previous study which investigated pellets produced at laboratory scale were confirmed when the pellets were produced at pilot scale.

A number of embodiments of the invention have been described. Nevertheless, it will be understood that various modifications may be made without departing from the spirit and scope of the invention. Accordingly, other embodiments are within the scope of the following claims.

### Example 8

### Preparation and Formulation of Yogurt Frozen Pellets

Frozen pellets containing yogurt (i.e., cultured milk products) and live yogurt bacterial cultures were prepared according to the general procedures of Example 1.

The following table sets forth various formulations for frozen yogurt pellets in accordance with the present disclosure.

TABLE 8
Composition of Yogurt-Containing Pellets

| | |
|---|---|
| Ingredient | % Weight (w/w) |

Mixed Berry Flavored Pellet

| | |
|---|---|
| Whole Milk | 72.385 |
| Sweet Cream | 2.300 |
| Non-Fat Dry Milk (NFDM) Powder | 6.750 |
| Granulated Sugar | 8.000 |
| Inulin (Cargill Oliggo-Fiber ® XL) | 3.250 |
| Stevia-based sweetener (Cargill Truvia ®) | 0.015 |
| Mixed Berry Flavor | 3.000 |
| Yogurt bacterial culture (CHR Hansen YC- | 0.012 |
| 380) | |
| Bifidobacterium animalis subsp. lactis | 0.025 |
| (BB12) culture | |
| Stabilizer (Cargill CitriTex ® 523) | 0.600 |
| Water | 0.463 |
| Whey Protein Concentration (80%) | 3.200 |

Strawberry Flavored Pellet

| | |
|---|---|
| Whole Milk | 71.245 |
| Sweet Cream | 3.040 |
| Non-Fat Dry Milk (NFDM) Powder | 6.750 |
| Granulated Sugar | 8.000 |
| Inulin (Cargill Oliggo-Fiber ® XL) | 3.250 |
| Stevia-based sweetener (Cargill Truvia ®) | 0.015 |
| Strawberry Flavor | 3.000 |
| Yogurt bacterial culture (CHR Hansen YC- | 0.012 |
| 380) | |
| Bifidobacterium animalis subsp. lactis | 0.025 |
| (BB12) culture | |
| Stabilizer (Cargill CitriTex ® 523) | 0.600 |
| Water | 0.463 |
| Whey Protein Concentration (80%) | 3.600 |

Strawberry-Banana Flavored Pellet

| | |
|---|---|
| Whole Milk | 75.045 |
| Sweet Cream | 2.800 |
| Non-Fat Dry Milk (NFDM) Powder | 6.750 |
| Granulated Sugar | 8.000 |
| Inulin (Cargill Oliggo-Fiber ® XL) | 3.250 |
| Stevia-based sweetener (Cargill Truvia ®) | 0.015 |
| Strawberry Flavor | 2.000 |
| Banana Flavor | 1.000 |
| Yogurt bacterial culture (CHR Hansen YC- | 0.012 |
| 380) | |
| Bifidobacterium animalis subsp. lactis | 0.025 |
| (BB12) culture | |
| Stabilizer (Cargill CitriTex ® 523) | 0.600 |
| Water | 0.463 |
| Whey Protein Concentration (80%) | 0.040 |

Peach-Mango Flavored Pellet

| | |
|---|---|
| Whole Milk | 75.507 |
| Sweet Cream | 2.800 |
| Non-Fat Dry Milk (NFDM) Powder | 6.750 |
| Granulated Sugar | 8.000 |
| Inulin (Cargill Oliggo-Fiber ® XL) | 3.250 |
| Stevia-based sweetener (Cargill Truvia ®) | 0.015 |
| Peach Flavor | 1.750 |
| Mango Flavor | 0.750 |
| Yogurt bacterial culture (CHR Hansen YC- | 0.012 |
| 380) | |
| Bifidobacterium animalis subsp. lactis | 0.600 |
| (BB12) culture | |
| Stabilizer (Cargill CitriTex ® 523) | 0.600 |
| Water | 0.463 |
| Whey Protein Concentration (80%) | 0.078 |

Melting temperatures for the yogurt pellets were generally as described above with respect to first and second pellets. Specifically, each of the yogurt pellets described in Table 8 had melting temperatures well above 0° F. (−17.7° C.). Accordingly, the yogurt pellets are considered to be temperature-stable at typical commercial grocery frozen distribution temperatures.

### Example 9

### Yogurt Smoothie Kits

Yogurt smoothie kits were prepared in accordance with the methods described herein using the frozen yogurt pellets of Example 8. Four different kits were assembled, each using one of the four frozen yogurt pellets of Example 8, in combination with frozen fruit pieces.

TABLE 9
Yogurt Smoothie Kits

| | |
|---|---|
| Component | Grams |

Mixed Berry Smoothie Kit

| | |
|---|---|
| Container- demarked with a 10.5 fluid ounce | N/A |
| (298 mL) lower volume for addition of | |
| mixing liquid | |
| Frozen Mixed Berry Flavored Pellets (Ex. 8) | 56.5 grams |
| Frozen strawberry and blueberry pieces | 56.5 grams |

Strawberry Smoothie Kit

| | |
|---|---|
| Container- demarked with a 10.5 fluid ounce | N/A |
| (192.2 mL) lower volume for mixing liquid. | |
| Strawberry Flavored Pellets (Ex. 8) | 56.5 grams |
| Frozen strawberry pieces | 56.5 grams |

Strawberry-Banana Smoothie Kit

| | |
|---|---|
| Container- demarked with a 10.5 fluid ounce | N/A |
| (192.2 mL) lower volume for mixing liquid. | |
| Strawberry-Banana Flavored Pellets (Ex. 8) | 56.5 grams |
| Frozen strawberry and banana pieces | 56.5 grams |

Peach-Mango Smoothie Kit

| | |
|---|---|
| Container- demarked with a 10.5 fluid ounce | N/A |
| (192.2 mL) lower volume for mixing liquid. | |
| Peach-Mango Flavored Pellets (Ex. 8) | 56.5 grams |
| Frozen peach and mango pieces | 56.5 grams |

Each container is provided with instructions to add fruit juice (e.g., orange juice) sufficient to fill the lower volume, that is, approximately 6.5 fluid ounces of fruit juice. The remainder of the 10.5 fluid ounce lower volume being occupied by the frozen yogurt pellets and the frozen fruit pieces (approximately 4 fluid ounces of volume, total).

The nutritional information for finished shakes made according to the Mixed Berry, Strawberry and Strawberry-Banana smoothie kits, using orange juice, is provided in the following table.

TABLE 10
Nutritional Information for Finished Yogurt
Smoothies (with 6.5 ounces of Orange Juice)

| | |
|---|---|
| | Value/% Recommended Daily Value |
| Component | (2000 Calorie Diet) |

Mixed Berry Smoothie Kit

| | |
|---|---|
| Total Calories | 190 |
| Calories from Fat | 20 |
| Total Fat (2 g) | 3% |
| Saturated Fats (1 g) | 5% |
| Cholesterol (10 mg) | 3% |
| Sodium (40 mg) | 2% |
| Total Carbohydrates (17 g) | 13% |
| Dietary Fiber (3 g) | 16% |
| Sugars (13 g) | N/A |
| Protein (5 g) | 12% |
| Vitamin A | 10% |
| Vitamin C | 220% |
| Calcium | 15% |
| Iron | 4% |

Strawberry Smoothie Kit

| | |
|---|---|
| Total Calories | 190 |
| Calories from Fat | 20 |
| Total Fat (2 g) | 3% |
| Saturated Fats (1 g) | 5% |
| Cholesterol (10 mg) | 3% |
| Sodium (35 mg) | 2% |
| Total Carbohydrates (17 g) | 13% |
| Dietary Fiber (5 g) | 20% |
| Sugars (12 g) | N/A |
| Protein (3 g) | N/A |
| Vitamin A | 10% |
| Vitamin C | 230% |
| Calcium | 10% |
| Iron | 4% |

Strawberry-Banana Smoothie Kit

| | |
|---|---|
| Total Calories | 190 |
| Calories from Fat | 20 |
| Total Fat (2 g) | 3% |
| Saturated Fats (1 g) | 5% |
| Cholesterol (10 mg) | 3% |
| Sodium (35 mg) | 2% |
| Total Carbohydrates (17 g) | 13% |
| Dietary Fiber (3 g) | 12% |
| Sugars (13 g) | N/A |
| Protein (4 g) | N/A |
| Vitamin A | 10% |
| Vitamin C | 270% |
| Calcium | 15% |
| Iron | 4% |

Using the Strawberry Smoothie Kit, 10 finished yogurt smoothies were prepared, and assayed for various finished properties. The kits were stored at approximately home freezer temperature prior to use and a 6.5 ounce portion of orange juice, stored at approximately home refrigerator temperature, was used as the mixing liquid for each smoothie. The results are presented in the following table.

TABLE 11

| | | | Viscosity | Brix |
|---|---|---|---|---|
| Sample | Temperature (° C.) | pH | (cP) | (° Bx) |
| 1 | | 4.06 | 3470 | 12.5 |
| 2 | 28.5 | 4.05 | 3523 | 12.5 |
| 3 | 28.7 | 4.06 | 2867 | 12.0 |
| 4 | 29.1 | 4.14 | 2973 | 12.5 |
| 5 | 28.8 | 4.08 | 3433 | 13.0 |
| 6 | 29.1 | 4.06 | 3113 | 12.0 |
| 7 | 28.5 | 4.06 | 3180 | 12.5 |
| 8 | 28.5 | 4.05 | 2973 | 12.0 |
| 9 | 28.7 | 4.05 | 2853 | 12.0 |
| 10 | 28.8 | 4.08 | 3800 | 12.5 |
| Mean | 28.7 | 4.1 | 3218.5 | 12.4 |
| St. Dev. | 0.32 | 0.03 | 321.53 | 0.34 |
| CV | 1.13% | .67% | 9.99% | 2.73% |

All ten samples displayed good bead dissolution, good texture, and good flavor.

A number of embodiments of the invention have been described herein. Nevertheless, it will be understood that various modifications may be made without departing from the spirit and scope of the subject matter. Accordingly, other embodiments are within the scope of the following claims.

What is claimed is:

1. A yogurt smoothie kit, the kit comprising:
a container having an inner volume, an open top end, a closed bottom end, and a demarcation positioned between the top end and the bottom end, the inner volume divided by the demarcation into an upper volume above the demarcation and a lower volume below the demarcation;
a plurality of frozen yogurt pellets, the frozen yogurt pellets comprising:
milk proteins;
milk fat;
yogurt bacterial cultures;
sugar;
and a stabilizer mix;
wherein:
the mass of the plurality of frozen yogurt pellets, in grams, is equal to between 0.090 and 0.275 times the volume of the lower volume, in milliliters;
the combined fat content of the plurality of frozen yogurt pellets, in grams, is equal to between 0.003 and 0.010 times the volume of the lower volume, in milliliters; and
the combined carbohydrate content of the plurality of frozen yogurt pellets, in grams, is equal to between 0.020 and 0.065 times the volume of the lower volume, in milliliters.

2. The yogurt smoothie kit of claim 1, further comprising:
a plurality of frozen fruit pieces;
wherein the mass of the plurality of frozen fruit pieces, in grams, is equal to between 0.090 and 0.275 times the volume of the lower volume, in milliliters.

3. The yogurt smoothie kit of claim 2, wherein the plurality of frozen fruit pieces includes fruit from the group consisting of strawberry, banana, blueberries, pineapple, mango, peach, pear, apple, orange and combinations thereof.

4. The yogurt smoothie kit of claim 2, wherein the combined mass, in grams, of the plurality of frozen yogurt pellets and the plurality of frozen fruit pieces is equal to between 0.180 and 0.550 times the volume of the lower volume, in milliliters.

5. The yogurt smoothie kit of claim 2, wherein the combined carbohydrate content, in grams, of the plurality of frozen yogurt pellets and the plurality of frozen fruit pieces is equal to between 0.027 and 0.082 times the volume of the lower volume, in milliliters.

6. The yogurt smoothie kit of claim 2, wherein the plurality of frozen yogurt pellets and the plurality of frozen fruit pieces, when mixed with a liquid having a concentration of sugar of about 0.086 g/ml, the liquid provided in a volume about equal to the lower volume, minus the volume displaced by the plurality of frozen yogurt pellets and the plurality of frozen fruit pieces, results in a smoothie having a Brix value between 8° Bx and 18° Bx.

7. The yogurt smoothie kit of claim 2, wherein the plurality of frozen yogurt pellets and the plurality of frozen fruit pieces, when mixed with water in a volume about equal to the lower volume, minus the volume displaced by the plurality of frozen yogurt pellets and the plurality of frozen fruit pieces, results in a smoothie having a Brix value between 8° Bx and 18° Bx.

8. The yogurt smoothie kit of claim 2, wherein the plurality of frozen yogurt pellets and the plurality of frozen fruit pieces, when mixed with a liquid, having a concentration of sugar of about 0.086 g/ml, in a volume about equal to the lower volume, minus the volume displaced by the plurality of frozen yogurt pellets and the plurality of frozen fruit pieces, results in a smoothie having a caloric content between 0.305 and 0.920 calories/ml.

9. The yogurt smoothie kit of claim 2, wherein the plurality of frozen yogurt pellets and the plurality of frozen fruit pieces, when mixed with water in a volume about equal to the lower volume, minus the volume displaced by the plurality of frozen yogurt pellets and the plurality of frozen fruit pieces, results in a smoothie having a caloric content between 0.305 and 0.920 calories/ml.

10. The yogurt smoothie kit of claim 2, wherein the combined dietary fiber content, in grams, of the plurality of frozen yogurt pellets and the plurality of frozen fruit pieces is equal to between 0.007 and 0.025 times the volume of the lower volume, in milliliters.

11. The yogurt smoothie kit of claim 1, further comprising:

[symbol]

12. A second plurality of frozen yogurt pellets, the beads of the second plurality of frozen yogurt pellets having a different composition than the beads of the plurality of frozen yogurt pellets.

13. The yogurt smoothie kit of claim 1, wherein the volume of the upper volume is 0.15 to 0.6 times the volume of the lower volume.

14. The yogurt smoothie kit of claim 1, wherein the lower volume is between 100 mL and 400 mL.
